(19) United States
(12) Patent Application Publication
(10) Pub. No.: US 2017/0280819 A1
(43) Pub. Date: Oct. 5, 2017

(54) ATHLETIC GEAR OR OTHER WEARABLE ARTICLES COMPRISING AN EXPANDABLE USER-ENGAGING STRUCTURE

(71) Applicant: BAUER HOCKEY LTD., Blainville (CA)

(72) Inventors: Jean-François CORBEIL, Prévost (CA); Ivan LABONTÉ, Montréal (CA); Alexis SÉGUIN, Laval (CA); Thierry KRICK, Coteau-du-Lac (CA)

(21) Appl. No.: 15/476,240

(22) Filed: Mar. 31, 2017

Related U.S. Application Data
(60) Provisional application No. 62/315,947, filed on Mar. 31, 2016.

(51) Int. Cl. A43B 5/16; A43B 7/02; A43B 5/06; A43B 23/07; A43B 23/02; A43B 3/26; A63B 71/10; A42B 3/32; A42B 3/12; A63B 71/12; A63B 71/14; B32B 5/20; B32B 5/32; B32B 7/02; A43B 1/14

(52) U.S. Cl. CPC A43B 5/1608; A43B 5/1616; A43B 5/1683; A43B 1/14; A43B 5/1625; A43B 7/025; A43B 5/06; A43B 23/07; A43B 23/028; A43B 3/26; A63B 71/10; A42B 3/324; A42B 3/125; A63B 71/1225; A63B 71/143; B32B 5/20; B32B 5/32; B32B 7/02; A63B 2071/125; A63B 2071/1258; A63B 2071/1266; B32B 2266/0278; B32B 2307/734; B32B 2437/02; B32B 2437/04; A63C 1/24

(57) ABSTRACT

A wearable article such as an article of athletic gear (e.g., a skate, an article of protective athletic equipment such as a helmet, etc.) wearable by a user and comprising an expandable user-engaging structure that is configured to be expanded (e.g., by heat or another stimulus) after manufacturing of the wearable article to conform it to the user or otherwise improve a fit of the wearable article on the user.

### CROSS-REFERENCE TO RELATED APPLICATION

This application claims priority from U.S. Provisional Patent Application 62/315,947 filed on Mar. 31, 2016 and incorporated by reference herein.

### FIELD

This disclosure generally relates to wearable gear such as athletic gear (e.g., skates, helmets, etc.) for sports or other athletic activities.

### BACKGROUND

Athletic gear is used by individuals engaging in sports and other athletic activities, such as hockey, lacrosse, baseball, softball and other bat-and-ball sports, football, etc.

For example, a hockey player wears hockey gear including skates, a helmet, arm guards (e.g., elbow pads), shoulder pads, leg guards, etc. An important aspect of designing hockey gear or athletic gear in general is to ensure its proper fit on the player's body. However, because commercially-available hockey gear is typically offered in different “standard sizes”, the player may have to settle for an approximate fit of his/her gear since anatomical dimensions of most players usually deviate from the available standard sizes. Such an approximate fit of the player's gear can be uncomfortable and in some cases could cause the player to get injured or be otherwise afflicted. For example, when the player wears a skate, a void space may be present between the player's foot and an inner surface of the skate. This can induce movement of the foot inside the skate which, in some cases, can cause bursitis or bunions.

While customized gear that is manufactured specifically for a user may be obtained in some cases, this may be expensive and therefore not a viable option for most individuals.

Similar considerations may arise for other types of wearable gear (e.g., other kinds of footwear like shoes).

For these and/or other reasons, there is a need for improvements directed to fit of athletic or other wearable gear.

### SUMMARY

In accordance with various aspects of this disclosure, there is provided a wearable article such as an article of athletic gear (e.g., a skate, an article of protective athletic equipment such as a helmet, etc.) wearable by a user and comprising an expandable user-engaging structure that is configured to be expanded (e.g., by heat or another stimulus) after manufacturing of the wearable article to conform it to the user or otherwise improve a fit of the wearable article on the user.

In accordance with an aspect of this disclosure, there is provided a wearable article for wearing by a user. The wearable article comprises an expandable user-engaging structure configured to expand to conform to the user. The expandable user-engaging structure comprises an expandable material.

In accordance with another aspect of this disclosure, there is provided a skate boot for a skate. The skate comprises a skating device disposed beneath the skate boot to engage a skating surface. The skate boot comprises a cavity to receive a foot of a user and an expandable user-engaging structure configured to expand to conform to the user's foot. The expandable user-engaging structure comprises an expandable material.

In accordance with another aspect of this disclosure, there is provided a skate boot for a skate. The skate comprises a skating device disposed beneath the skate boot to engage a skating surface. The skate boot comprises a cavity to receive a foot of a user and an expandable user-engaging structure configured to expand to conform to the user's foot. The expandable user-engaging structure comprises a container configured to receive a filling material causing expansion of the container.

In accordance with another aspect of this disclosure, there is provided footwear that comprises a cavity to receive a foot of a user and an expandable user-engaging structure configured to expand to conform to the user's foot. The expandable user-engaging structure comprises an expandable material.

In accordance with another aspect of this disclosure, there is provided a helmet for protecting a head of a user. The helmet comprises an outer shell and a liner disposed within the outer shell. The liner comprises an expandable user-engaging structure configured to expand to conform to the user's head. The expandable user-engaging structure comprises an expandable material.

These and other aspects of this disclosure will now become apparent to those of ordinary skill in the art upon review of the following description of embodiments in conjunction with the accompanying drawings.

### BRIEF DESCRIPTION OF DRAWINGS

A detailed description of embodiments is provided below, by way of example only, with reference to drawings annexed hereto, in which:

FIG. 1 is an example of a wearable article, in this case an article of athletic gear, wearable by a user and comprising an expandable user-engaging structure in accordance with an embodiment, in which the article of athletic gear is a skate;

FIG. 2 is an exploded view of the skate, including the expandable user-engaging structure as comprised by a liner of a skate boot of the skate in one example;

FIGS. 3 to 6 show a front perspective view, a rear perspective view, a side view and top cross-sectional view of a toe cap of the skate boot;

FIG. 7 shows a perspective view of a tongue of the skate boot;

FIG. 8 shows an exploded view of the tongue;

FIG. 9 shows the expandable user-engaging structure in an initial shape and in an expanded shape after having been expanded from its initial shape;

FIG. 10 shows a perspective view of the expandable user-engaging structure of the liner;

FIG. 11 shows the expandable user-engaging structure in an original shape prior to molding and in its initial shape after molding and prior to being expanded;

FIG. 12 shows at least a part of the expandable user-engaging structure being bonded to a shell of the skate boot;

FIG. 13 is a flow diagram of an example of a process for expanding the expandable user-engaging structure in order to conform it to the user's foot or otherwise improve the fit of the skate on the user's foot;

FIGS. 14A and 14B are respective longitudinal and transversal cross-sectional views of the skate boot in which the expandable user-engaging structure is in its initial shape;

FIGS. 15A and 15B are respective longitudinal and transversal cross-sectional views of the skate boot in which the expandable user-engaging structure is in its expanded shape after being exposed to a stimulus (e.g., heat) that expands the expandable user-engaging structure;

FIG. 16 is a side view of a blade of a skating device of the skate;

FIG. 17 is a side view of a blade holder of the skating device of the skate;

FIGS. 18 to 21 are examples of different ways in which the blade may be secured to the blade holder;

FIGS. 22A, 22B and 22C are examples of embodiments in which the expandable user-engaging structure comprises a lining overlying an expandable material of the expandable user-engaging structure;

FIG. 23 is a longitudinal cross-sectional view of the skate boot in an example of an embodiment in which the expandable user-engaging structure extends over less than a height of the skate boot;

FIG. 24 is a block diagram of an example of a composition of the expandable material of the expandable user-engaging structure;

FIG. 25 is an example of the expandable material of the expandable user-engaging structure in which the expansion agent comprises expandable microspheres;

FIGS. 26A and 26B are perspective views of the expandable user-engaging structure in accordance with embodiments in which the expandable user-engaging structure comprises a plurality of expandable materials;

FIG. 27 is a perspective view of the expandable user-engaging structure in accordance with a variant in which two or more of the expandable materials overlap;

FIG. 28 is a longitudinal cross-sectional view of the skate boot in accordance with an embodiment in which the expandable user-engaging structure comprises a toe portion;

FIG. 29 is a perspective view of the liner in accordance with the embodiment of FIG. 28;

FIG. 30 shows a variant of the liner of FIG. 29 in which the toe portion of the expandable user-engaging structure comprises medial and lateral extensions;

FIGS. 31 and 32 are longitudinal cross-sectional views of the skate boot in accordance with embodiments in which the skate comprises a heater for generating heat to expand the expandable user-engaging structure;

FIG. 33 shows an electrical connector of the heater of the skate electrically connected to an external electrical power source;

FIG. 34 shows a perspective view of a cross-section of the expandable user-engaging structure in accordance with an embodiment in which the expandable user-engaging structure comprises a container;

FIGS. 35 and 36 show the container of the expandable user-engaging structure of FIG. 34 in its initial shape and in its final shape after it has been expanded;

FIG. 37 shows an example of a port of the expandable-user engaging structure of FIG. 34;

FIG. 38 is a cross-sectional view of another embodiment of the blade holder in accordance to which the blade holder comprises a blade-detachment mechanism;

FIGS. 39 and 40 are respective side and cross-sectional views of another embodiment of the blade in accordance to which the blade comprises a runner;

FIG. 41 shows a variant in which the expandable user-engaging structure comprises a retainer and a plurality of expandable elements attached to the retainer;

FIG. 42 shows another example of the variant of FIG. 41 in which the retainer comprises a mesh;

FIG. 43 shows another example of the variant of FIG. 41 in which the expandable user-engaging structure comprises a filler disposed between the expandable elements;

FIG. 44 shows another example of the variant of FIG. 41 in which the retainer comprises a layer disposed between the expandable elements and a lining for contacting the user's foot;

FIG. 45 shows another example of a variant of FIG. 41 in which the retainer comprises a covering forming a plurality of internal spaces in which are housed the expandable elements;

FIG. 46 is a perspective view of the expandable user-engaging structure in accordance with the variant of FIG. 42, in which the expandable user-engaging structure is in its initial shape prior to expansion;

FIG. 47 is a perspective view of the expandable user-engaging structure in accordance with the variant of FIG. 42, in which the expandable user-engaging structure is in its expanded shape after expansion;

FIG. 48 shows a variant in which the shell of the skate boot is clear;

FIG. 49 shows a variant in which the expandable user-engaging structure comprises a sole portion and a tongue portion;

FIG. 50 is another example of footwear wearable by the user and comprising an expandable user-engaging structure in accordance with another embodiment, in which the footwear is a ski boot;

FIG. 51 is another example of footwear wearable by the user and comprising an expandable user-engaging structure in accordance with another embodiment, in which the footwear is a running shoe;

FIGS. 52A, 52B and 53 show an example of a footbed comprising an expandable user-engaging structure in accordance with another embodiment;

FIG. 54 is an example of another article of athletic gear wearable by the user and comprising an expandable user-engaging structure in accordance with an embodiment, in which the article of athletic gear is a helmet;

FIGS. 55 and 56 show a front view and a rear perspective view of the helmet;

FIGS. 57 to 61 show operation of an example of an adjustment mechanism of the helmet;

FIGS. 62 and 63 show an example of shell members of an outer shell of the helmet;

FIGS. 64 to 68 show examples of a plurality of pads of a padding of the expandable user-engaging structure;

FIGS. 69A and 69B are an example of another article of athletic gear wearable by the user and comprising an expandable user-engaging structure in accordance with another embodiment, in which the article of athletic gear is an arm guard;

FIGS. 70A and 70B is an example of another article of athletic gear wearable by the user and comprising an expandable user-engaging structure in accordance with another embodiment, in which the article of athletic gear is a leg guard;

FIG. 71 is an example of another article of athletic gear wearable by the user and comprising an expandable user-engaging structure in accordance with another embodiment, in which the article of athletic gear is a goalie leg pad;

FIG. 72 is an example of another article of athletic gear wearable by the user and comprising an expandable user-engaging structure in accordance with another embodiment, in which the article of athletic gear is shoulder pads;

FIGS. 73A and 73B show an example of another article of athletic gear wearable by the user and comprising an expandable user-engaging structure in accordance with another embodiment, in which the article of athletic gear is a protective glove;

FIGS. 74 and 75 are side and front views of a right foot of the user with an integument of the foot shown in dotted lines and bones shown in solid lines; and

FIGS. 76 and 77 show a head of the user.

In the drawings, embodiments are illustrated by way of example. It is to be expressly understood that the description and drawings are only for purposes of illustration and as an aid to understanding, and are not intended to be limitative.

### DETAILED DESCRIPTION OF EMBODIMENTS

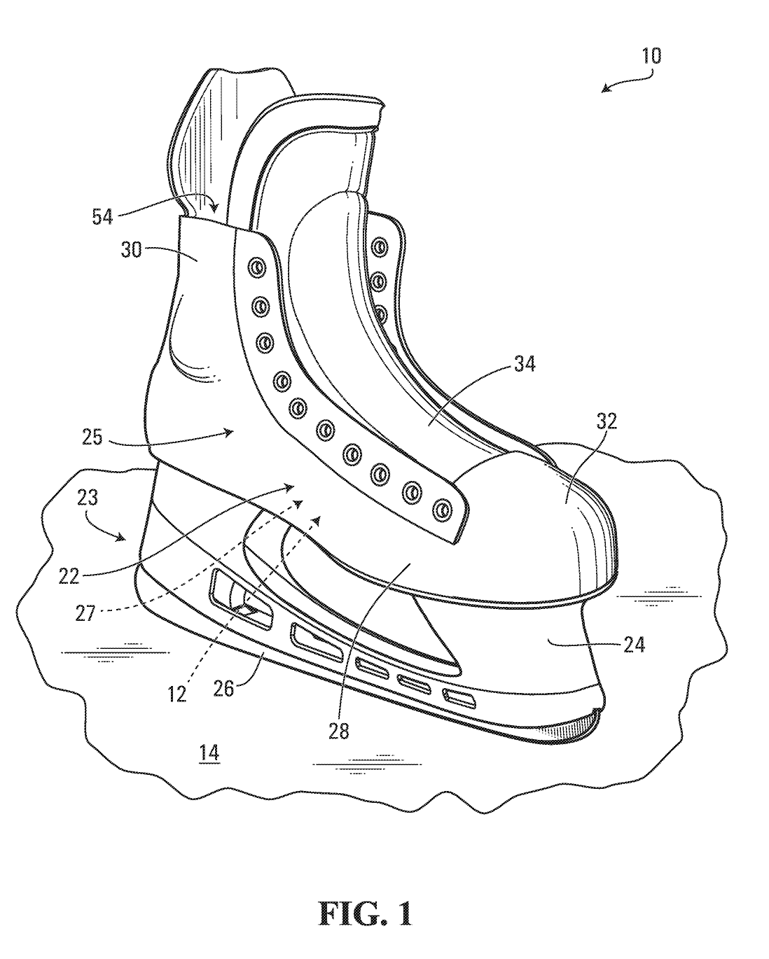

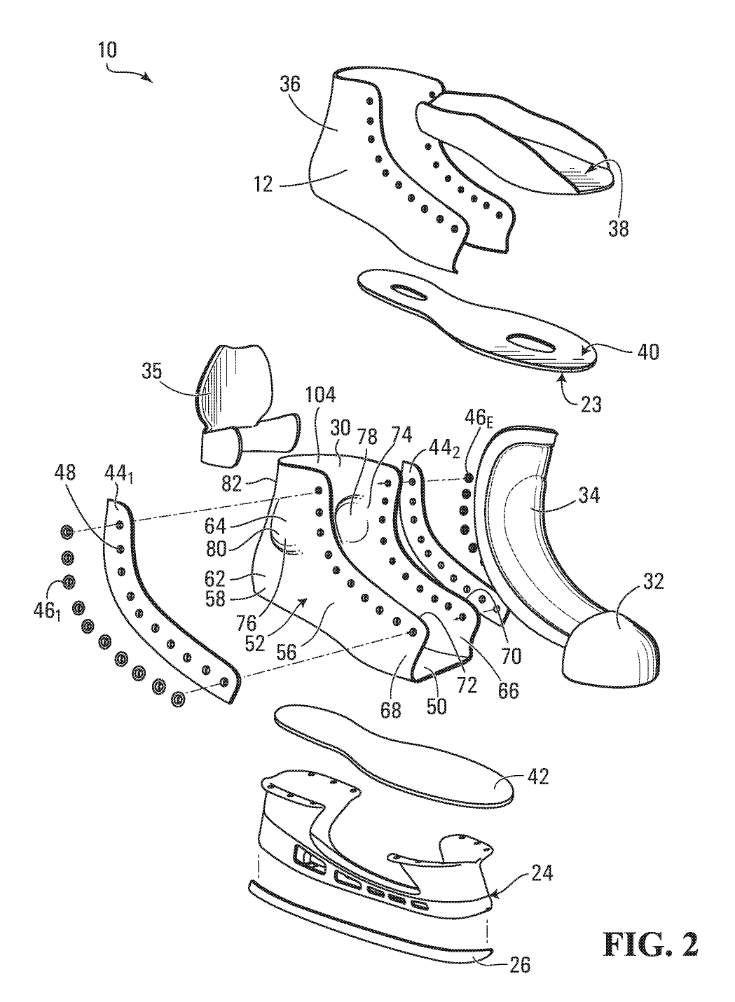

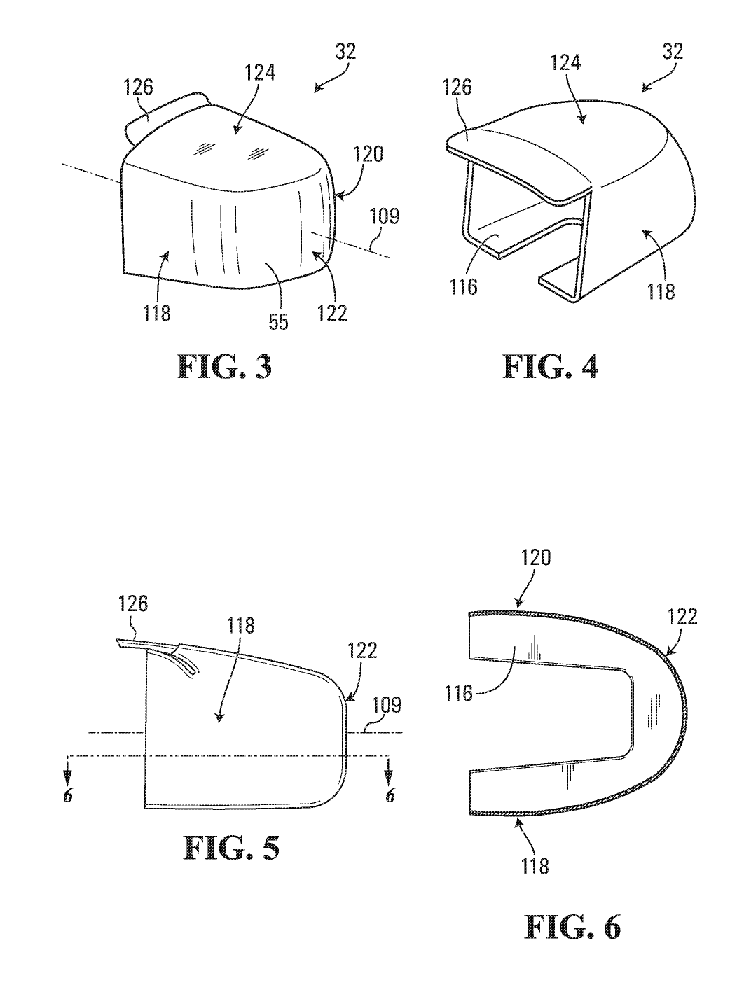

FIG. 1 shows an example of a wearable article 10 that is wearable by a user and comprises an expandable user-engaging structure 12 in accordance with an embodiment. In this embodiment, the wearable article 10 is an article of athletic gear for the user who is engaging in a sport or other athletic activity. More particularly, in this embodiment, the article of athletic gear 10 is a skate wearable on a foot of the user to skate on a skating surface 14. In this case, the skate 10 is a hockey skate for the user who is a hockey player playing hockey. In this example, the skate 10 is an ice skate, a type of hockey played is ice hockey, and the skating surface 14 is ice.

The skate 10 comprises a skate boot 22 for receiving a foot 11 of the player and a skating device 23 disposed beneath the skate boot 22 to engage the skating surface 14. In this embodiment, the skating device 23 comprises a blade 26 for contacting the ice 14 and a blade holder 24 between the skate boot 22 and the blade 26. The skate 10 has a longitudinal direction, a widthwise direction, and a heightwise direction.

The expandable user-engaging structure 12 of the skate 10 is a part of the skate 10 that is configured to be expanded (e.g., by heat or another stimulus) after manufacturing of the skate 10 to conform it to the player's foot 11 or otherwise improve a fit of the skate 10 on the player's foot 11. This may allow the skate 10 to be customized for the hockey player (e.g., by custom-fitting it to the player in-store or at another location where it can be expanded to conform to the player's foot 11), which may help to improve skating performance. More particularly, as further discussed below, in this embodiment, the skate boot 22 comprises the expandable user-engaging structure 12 to allow the skate boot 22 to conform to the player's foot by expanding and filling space between the skate boot 22 and the player's foot.

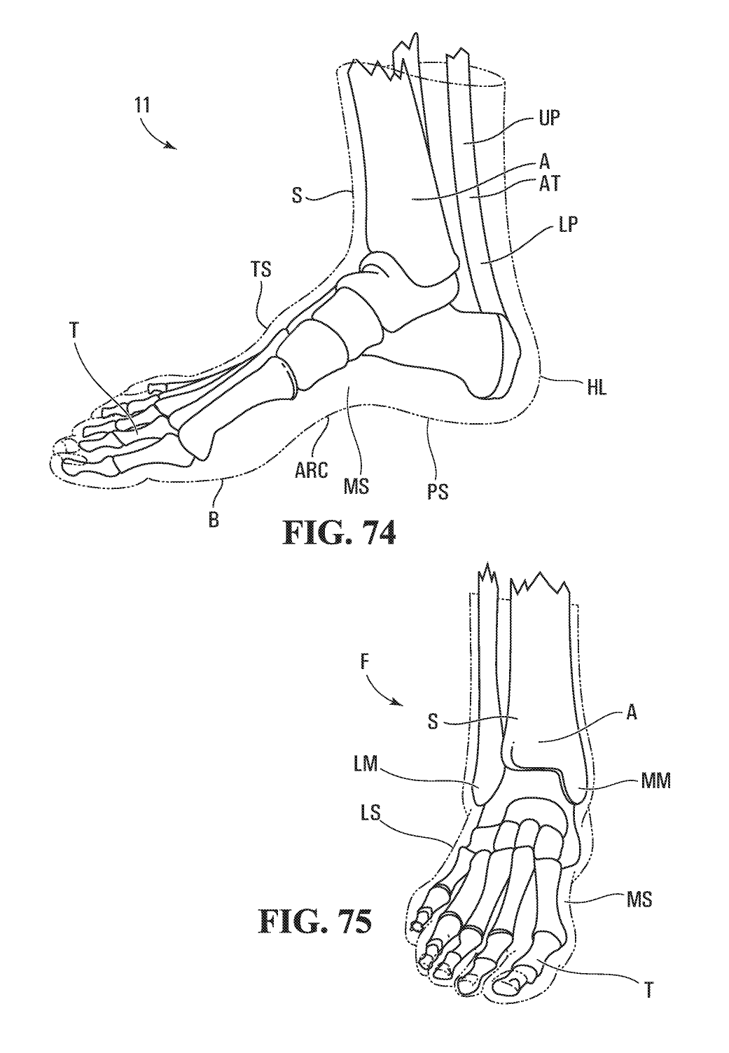

The skate boot 22 defines a cavity 54 for receiving the player's foot. With additional reference to FIGS. 74 and 75, the player's foot 11 includes toes T, a ball B, an arch ARC, a plantar surface PS, a top surface TS, a medial side MS, and a lateral side LS. The top surface TS of the player's foot 11 is continuous with a lower portion of a shin S of the player. In addition, the player has a heel HL, an Achilles tendon AT, and an ankle A having a medial malleolus MM and a lateral malleolus LM that is at a lower position than the medial malleolus MM. The Achilles tendon AT has an upper part UP and a lower part LP projecting outwardly with relation to the upper part UP and merging with the heel HL. A forefoot of the player includes the toes T and the ball B, a hindfoot of the player includes the heel HL, and a midfoot of the player is between the forefoot and the hindfoot.

In this embodiment, the skate boot 22 comprises an outer portion 25 and an inner portion 27 that includes the expandable user-engaging structure 12. The outer portion 25 includes an outer surface 28 of the skate boot 12 and the inner portion 27 includes an inner surface 29 of the skate boot 22 that faces the player's foot 11.

More particularly, in this embodiment, the outer portion 25 of the skate boot 22 comprises a shell 30, a toe cap 32, a tongue 34, a tendon guard 35, and an outsole 42, and the inner portion 27 of the skate boot 22 comprises a liner 36, a footbed 38, and an insole 40. The skate boot 22 also comprises lace members 44₁, 44₂ and eyelets 46₁-46_{E} extending through (e.g., punched into) the lace members 44₁, 44₂, the shell 30 and the liner 36 vis-à-vis apertures 48 in order to receive laces for tying on the skate 10. In some embodiments, the skate boot 22 may not comprise any lace members and the eyelets 46₁-46_{E} may extend directly through the shell 30 and the liner 36 via the apertures 48.

The shell 30 imparts strength and structural integrity to the skate 10 to support the player's foot 11. More particularly, in this embodiment, the shell 30 comprises a heel portion 62 for receiving the heel HL of the player, an ankle portion 64 for receiving the ankle A of the player, medial and lateral side portions 66, 68 for respectively facing the medial and lateral sides MS, LS of the player's foot 11, and a sole portion 50 for facing the plantar surface PS of the player's foot 11. The shell 30 thus includes a quarter 52 which comprises a medial quarter part 54, a lateral quarter part 56, and a heel counter 58. The medial and lateral side portions 66, 68 include upper edges 70, 72 which connect to the lace members 44₁, 44₂. The heel portion 62 may be formed such that it is substantially cup-shaped for following the contour of the heel HL of the player. The ankle portion 64 comprises medial and lateral ankle sides 74, 76. The medial ankle side 74 has a medial depression 78 for receiving the medial malleolus MM of the player and the lateral ankle side 76 has a lateral depression 80 for receiving the lateral malleolus LM of the player. The lateral depression 80 is located slightly lower than the medial depression 78 according to morphology of the player's foot 11. The ankle portion 64 further comprises a rear portion 82 facing the lower part LP of the Achilles tendon AT of the player.

The shell 30 may comprise any suitable material. For example, in some embodiments, the shell 30 may comprise one or more polymeric materials, such as polyurethane (PU), polypropylene, ethylene-vinyl acetate (EVA), nylon, polyester, vinyl, polyvinyl chloride, polycarbonate, polyethylene, an ionomer resin (e.g., Surlyn®), styrene-butadiene copolymer (e.g., K-Resin®) etc.), self-reinforced polypropylene composite (e.g., Curve), or any other thermoplastic or thermosetting polymer. In some embodiments, a polymeric material of the shell 30 may be a composite material. For example, the composite material may be a fiber-matrix composite material that comprises a matrix in which fibers are embedded. The matrix may include any suitable polymeric resin, such as a thermosetting polymeric material (e.g., polyester, vinyl ester, vinyl ether, polyurethane, epoxy, cyanate ester, etc.), a thermoplastic polymeric material (e.g., polyethylene, polyurethane, polypropylene, acrylic resin, polyether ether ketone, polyethylene terephthalate, polyvinyl chloride, polymethyl methacrylate, polycarbonate, acrylonitrile butadiene styrene, nylon, polyimide, polysulfone, polyamide-imide, self-reinforcing polyphenylene, etc.), or a hybrid thermosetting-thermoplastic polymeric material. The fibers may be made of any suitable material such as carbon fibers, polymeric fibers such as aramid fibers, boron fibers, glass fibers, ceramic fibers, etc.

The shell 30 may be constructed in any suitable way. For example, in some embodiments, one or more materials of the shell 30 may be thermoformed (e.g., one or more sheets of materials may be thermoformed in a mold into a shape of the shell 30). As another example, in some embodiments, one or more materials of the shell 30 may be formed onto a last. As yet another example, in some embodiments, one or more materials of the shell 30 may be molded into the shape of the shell 30 by flowing in a molding apparatus during a molding process (e.g., injection molding or casting).

The toe cap 32 is configured to face and protect the toes T of the player's foot 11. In this example, the toe cap 32 is affixed to the inner surface of the shell 30 at the medial and lateral side portions 66, 68 of the shell 30. The toe cap 32 extends along a longitudinal axis 109 comprises a bottom portion 116 for at least partially covering a front portion of a lower surface 23 of the insole 40, a lateral side portion 118 for facing a small toe of the player's foot 11, a medial side portion 120 for facing a big toe of the player's foot 11, an end portion 122 between the lateral and medial side portions 118, 120, an upper portion 124 for facing a top of the toes T of the player's foot 11, and a top extension 126 for affixing the tongue 34 to the toe cap 32. The top extension 126 of the toe cap 32 may be affixed (e.g., glued and/or stitched) to a distal end portion of the tongue 34 in order to affix the tongue 34 to the toe cap 32.

The toe cap 32 comprises a synthetic material 55 that imparts stiffness to the toe cap 32. For instance, in various embodiments, the synthetic material 55 of the toe cap 32 may comprise nylon, polycarbonate materials (e.g., Lexan®), polyurethane, thermoplastics, thermosetting resins, reinforced thermoplastics, reinforced thermosetting resins, polyethylene, polypropylene, high density polyethylene or any other suitable material. In some cases, the synthetic material 55 of the toe cap 32 may be a composite material comprising thermoset material, thermoplastic material, carbon fibers and/or fiberglass fibers. For example, the composite material may be a fiber-matrix composite material that comprises a matrix in which fibers are embedded. The matrix may include any suitable polymeric resin, such as a thermosetting polymeric material (e.g., polyester, vinyl ester, vinyl ether, polyurethane, epoxy, cyanate ester, etc.), a thermoplastic polymeric material (e.g., polyethylene, polyurethane, polypropylene, acrylic resin, polyether ether ketone, polyethylene terephthalate, polyvinyl chloride, polymethyl methacrylate, polycarbonate, acrylonitrile butadiene styrene, nylon, polyimide, polysulfone, polyamide-imide, self-reinforcing polyphenylene, etc.), or a hybrid thermosetting-thermoplastic polymeric material. The fibers may be made of any suitable material such as carbon fibers, polymeric fibers such as aramid fibers, boron fibers, glass fibers, ceramic fibers, etc.

The outsole 42 is affixed to an underside of the shell 30. The outsole 42 comprises a rigid material for imparting rigidity to the outsole 42. More particularly, in this embodiment, the rigid material of the outsole 42 comprises a composite material. For example, the composite material may be a fiber-matrix composite material that comprises a matrix in which fibers are embedded. The matrix may include any suitable polymeric resin, such as a thermosetting polymeric material (e.g., polyester, vinyl ester, vinyl ether, polyurethane, epoxy, cyanate ester, etc.), a thermoplastic polymeric material (e.g., polyethylene, polypropylene, acrylic resin, polyether ether ketone, polyethylene terephthalate, polyvinyl chloride, polymethyl methacrylate, polycarbonate, acrylonitrile butadiene styrene, nylon, polyimide, polysulfone, polyamide-imide, self-reinforcing polyphenylene, etc.), or a hybrid thermosetting-thermoplastic polymeric material. The fibers may be made of any suitable material such as carbon fibers, polymeric fibers such as aramid fibers, boron fibers, glass fibers, ceramic fibers, etc. In other embodiments, the rigid material may comprise any other suitable material (e.g., nylon, polycarbonate materials, polyurethane, thermoplastics, thermosetting resins, reinforced thermoplastics, reinforced thermosetting resins, polyethylene, polypropylene, high density polyethylene).

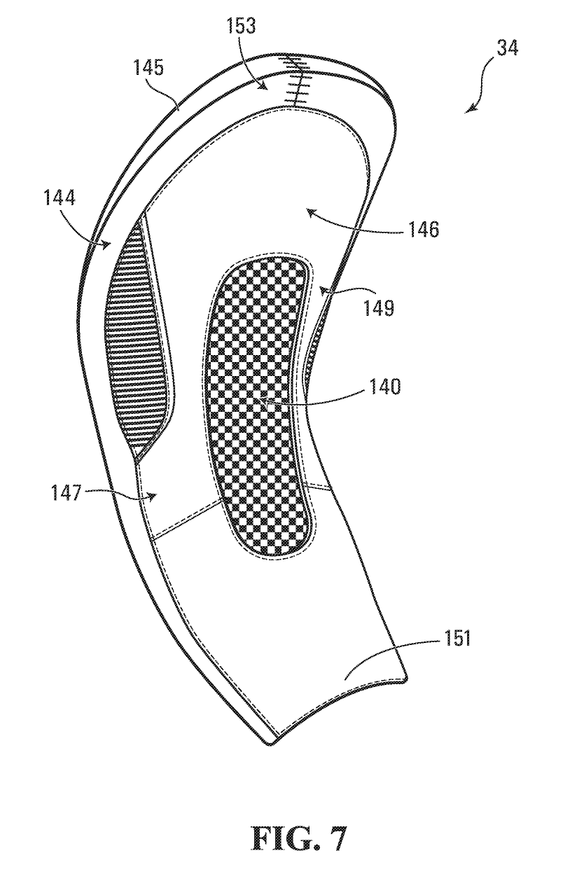

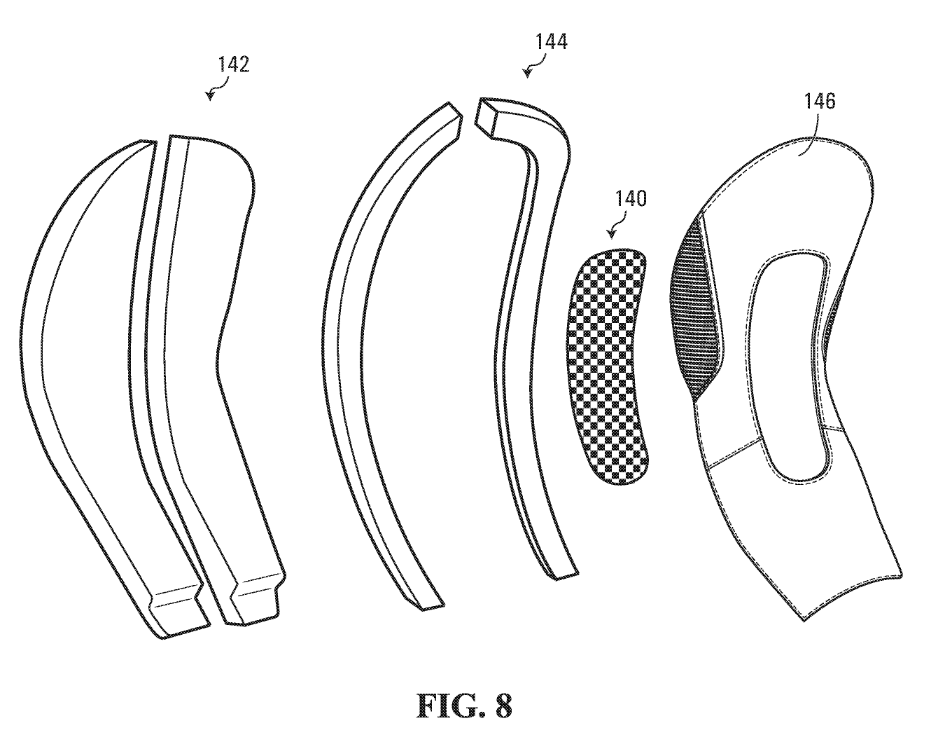

The tongue 34 extends upwardly and rearwardly from the toe cap 32 for overlapping the top surface TS of the player's foot 11. In this embodiment, with additional reference to FIGS. 7 and 8, the tongue 34 comprises a core 140 defining a section of the tongue 34 with increased rigidity, a padding member 142 for absorbing impacts to the tongue 34, a peripheral member 144 for at least partially defining a periphery 145 of the tongue 34, and a cover member 146 configured to at least partially define a front surface of the tongue 34. The tongue 34 defines a lateral portion 147 overlying a lateral portion of the player's foot 11 and a medial portion 149 overlying a medial portion of the player's foot 11. The tongue 34 also defines a distal end portion 151 for affixing to the toe cap 32 (e.g., via stitching) and a proximal end portion 153 that is nearest to the player's shin S.

The tendon guard 35 extends upwardly from the rear portion 82 of the ankle portion 64 of the shell 30 in order to protect the player's Achilles tendon AT. In this embodiment, the tendon guard 35 is a separate component that is fastened to the shell 30 via a mechanical fastener (e.g., via stitching, stapling, a screw, etc.) or in any other suitable way (e.g., ultrasonic welding). In other embodiments, the tendon guard 35 may be integrally formed with the shell 30 during forming of the shell 30.

The inner portion 27 of the skate boot 22 is disposed between the outer portion 25 of the skate boot 22 and the player's foot 11 when the skate 10 is worn and comprises the expandable user-engaging structure 12. In this embodiment, the liner 36 comprises the expandable user-engaging structure 12, which comprises a user-engaging surface 75 that constitutes at least part of the inner surface 29 of the skate boot 22.

The expandable user-engaging structure 12 of the liner 36 is configured to be expanded (e.g., by heat or another stimulus) after manufacturing of the skate 10 to conform to the player's foot 11 or otherwise improve the fit of the skate 10 on the player's foot 11. Expansion of the expandable user-engaging structure 12 can fill space between the skate boot 22 and the player's foot 11 that may otherwise remain void. This may help to enhance skating performance, such as by reducing relative movement between the player's foot 11 and the skate boot 22 to thereby better transfer forces between the player's foot 11 and the skate boot 22 while skating.

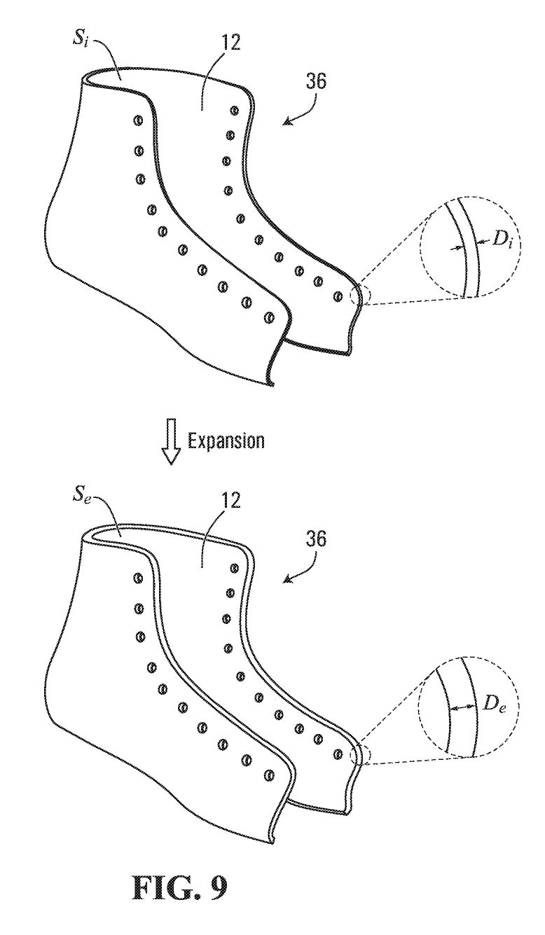

Thus, as shown in FIG. 9, the expandable user-engaging structure 12 of the liner 36 has an initial shape Sᵢ upon manufacturing of the skate boot 22 and can be expanded after manufacturing of the skate boot 22 to have an expanded shape Sₑ in which a dimension Dₑ of the expandable user-engaging structure 12 is larger than a dimension Dᵢ of the expandable user-engaging structure 12 in its initial shape Sᵢ. For example, in this embodiment, the dimension Dᵢ of the expandable user-engaging structure 12 is a thickness of a part 78 of the expandable user-engaging structure 12 in its initial shape Sᵢ and the dimension Dₑ of the expandable user-engaging structure 12 is a thickness of that part 78 of the expandable user-engaging structure 12 in its expanded shape Sₑ.

An expansion ratio of the expandable user-engaging structure 12 of the liner 36, which refers to a ratio of the dimension Dₑ (in this case, the thickness) of the expandable user-engaging structure 12 in its expanded shape Sₑ over the dimension Dᵢ (in this case, the thickness) of the expandable user-engaging structure 12 in its initial shape Sᵢ, may be relatively high. For example, in some embodiments, the expansion ratio of the expandable user-engaging structure 12 may be at least 1.1, in some cases at least 1.3, in some cases at least 1.5, in some cases at least 1.7, in some cases at least 1.9, and in some cases even more (e.g., 2 or more). The expansion ratio of the expandable user-engaging structure 12 may have any other suitable value in other embodiments.

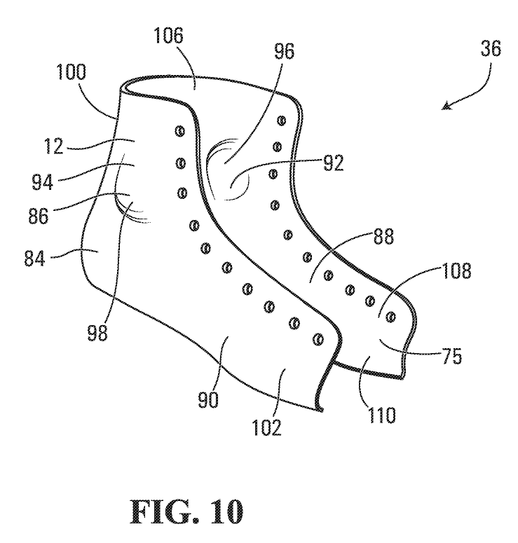

In this embodiment, as shown in FIG. 10, the expandable user-engaging structure 12 of the liner 36 comprises a heel portion 84 for receiving the heel HL of the player, an ankle portion 86 for receiving the ankle A of the player, and medial and lateral side portions 88, 90 for respectively facing the medial and lateral sides MS, LS of the player's foot 11. The heel portion 84, the ankle portion 86, and the medial and lateral side portions 88, 90 include respective parts of the user-engaging surface 75. The heel portion 84 may be formed such that it is substantially cup-shaped for following the contour of the heel HL of the player. The ankle portion 86 comprises medial and lateral ankle sides 92, 94. The medial ankle side 92 has a medial depression 96 for receiving the medial malleolus MM of the player and the lateral ankle side 94 has a lateral depression 98 for receiving the lateral malleolus LM of the player. The lateral depression 98 is located slightly lower than the medial depression 96 according to morphology of the player's foot 11. The ankle portion 86 further comprises a rear portion 100 facing the lower part LP of the Achilles tendon AT of the player. Thus, in this embodiment, the expandable user-engaging structure 12 of the liner 36 includes an outer surface 102 that is opposite to its user-engaging surface 75 and generally corresponds to an inner surface 104 of the shell 30.

The expandable user-engaging structure 12 of the liner 36 may be implemented in any suitable way. In this embodiment, the expandable user-engaging structure 12 comprises an expandable material 106. In this example, the heel portion 84, the ankle portion 86, and the medial and lateral side portions 88, 90 of the expandable user-engaging structure 12 comprise respective parts of the expandable material 106. More particularly, in this example, the expandable material 106 constitutes a layer 108 that includes the heel portion 84, the ankle portion 86, and the medial and lateral side portions 88, 90 of the expandable user-engaging structure 12. In this embodiment, the expandable material 106 includes the user-engaging surface 75.

The expandable material 106 can be any material capable of expanding. In this embodiment, the expandable material 106 comprises a cellular material 110. More particularly, in this embodiment, the cellular material 110 is a foam. For instance, in some embodiments, the foam 110 may be polyurethane (PU) foam, expanded polypropylene (EPP) foam, expanded polyethylene (EPE) foam, vinyl nitrile (VN) foam, or any other suitable polymeric foam material. In other embodiments, the foam 110 may be a silicone foam, a rubber foam, a latex foam or any other suitable elastomer or co-elastomer based foam.

The expandable user-engaging structure 12 of the liner 36 may be provided in any suitable way. In this embodiment, the foam 110 is shaped during a molding process using a mold to impart the initial shape Sᵢ of the expandable user-engaging structure 12. The molding process may be carried out in various ways. For example, the molding process may be a thermoforming process which involves thermoforming a sheet of the foam 110 by heating the sheet and then forming it using a mold. In this example, the sheet of foam 110 may be thermoformed over at least part of an inner surface of the shell 30. As another example, the foam 110 may be formed onto a last (i.e., a male mold around which is disposed a forming material to acquire the shape of the male mold). As yet another example, the foam 110 may be molded into the initial shape Sᵢ of the expandable user-engaging structure 12 by flowing in a molding apparatus that includes a mold (e.g., injection molding or casting). For example, the foam 110 may be injected over at least part of the inner surface of the shell 30.

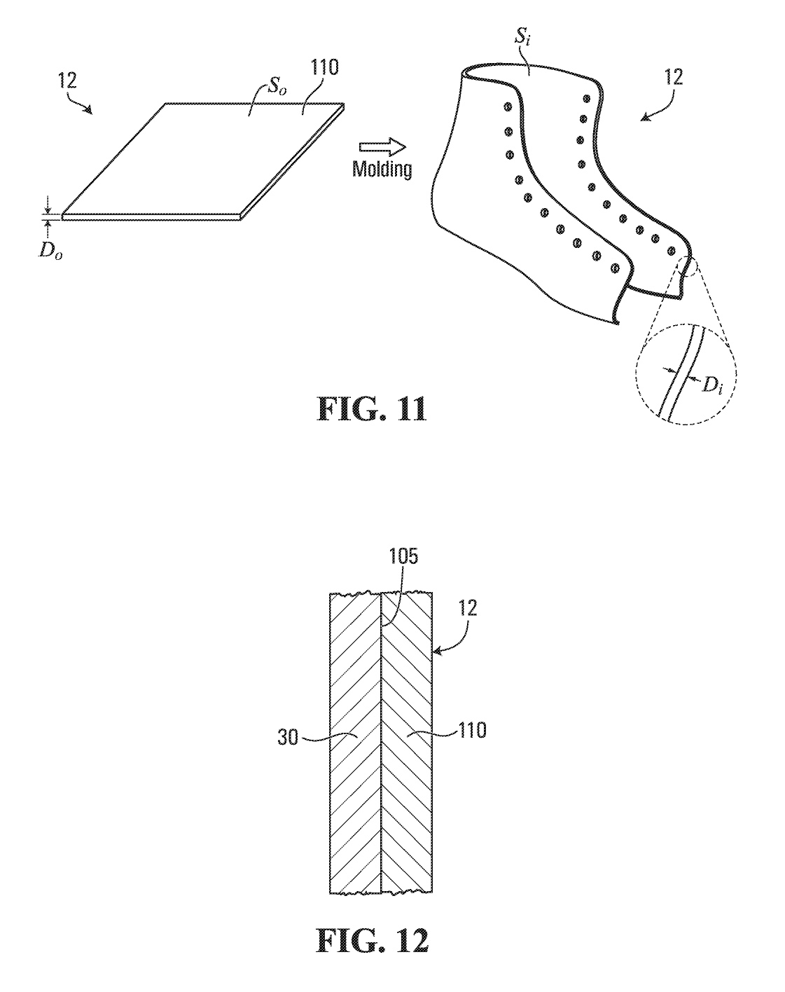

In this embodiment, during the molding process, as shown in FIG. 11, the expandable user-engaging structure 12 of the liner 36, notably the foam 110, originally has a shape Sₒ and is compressed into its initial shape Sᵢ such that a dimension Dₒ (in this case, a thickness) of the foam 110 is larger than the dimension Dᵢ (in this case, the thickness) of the foam 110 in its initial shape Sᵢ. For instance, in some embodiments, the dimension Dₒ may be at least as great as (i.e., as great or greater than) the dimension D. For example, in some embodiments, a ratio Dₒ/Dᵢ of the dimension Dₒ over the dimension Dᵢ may be at least 1, in some cases at least 1.1, in some cases at least 1.2, in some cases at least 1.3 and in some cases even more (e.g., 1.4).

In other embodiments, the dimension Dₒ may be smaller than the dimension D. For instance, in such embodiments, the ratio Dₒ/Dᵢ may be less than 1, in some cases no more than 0.9, in some cases no more than 0.8 and in some cases even less (e.g., 0.7).

In this embodiment, the expandable user-engaging structure 12 of the liner 36 is affixed to a remainder of the skate boot 22 such that it is an integral element of the skate boot 22. That is, the expandable user-engaging structure 12 is not intended to be removed from the skate boot 22. More particularly, in this embodiment, the expandable user-engaging structure 12 is bonded to the shell 30.

The expandable user-engaging structure 12 may be bonded to the shell 30 in various ways. For example, as shown in FIG. 12, the expandable user-engaging structure 12 may be adhesively bonded to the shell 30 via an adhesive 105. As another example, the expandable user-engaging structure 12 may be chemically bonded to the shell 30 during provision of the expandable user-engaging structure 12 in the shell 30 (e.g., a chemical reaction between a material of the user-engaging structure 12 and a material of the shell 30).

In other embodiments, the expandable user-engaging structure 12 may be fastened to the remainder of the skate boot 22 in any suitable way. For example, the expandable user-engaging structure 12 may be fastened to the remainder of the skate boot 22 by one or more mechanical fasteners (e.g., screws, rivets, tracks, stitches, etc.).

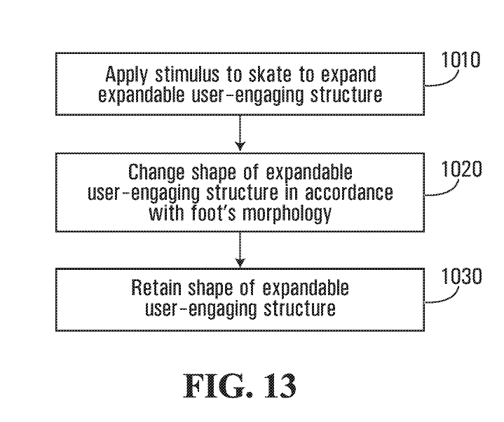

Expansion of the expandable user-engaging structure 12 of the liner 36 may be effected in any suitable way. An example of a process for expanding the expandable user-engaging structure 12 of the liner 36 in order to conform it to the player's foot or otherwise improve the fit of the skate 10 on the player's foot 11 will now be described with additional reference to FIGS. 13 to 15B.

In this embodiment, the expandable user-engaging structure 12, notably the expandable material 106, is configured to expand in response to a stimulus. In this example, the stimulus is heat applied to the expandable user-engaging structure 12. At step 1010, therefore, heat is applied to the expandable user-engaging structure 12 in order to expand it. This causes an increase in temperature of the expandable material 106.

More particularly, in this embodiment, the foam 110 of the expandable user-engaging structure 12 of the liner 36 may be expanded by heat from a heat source 95. In this example, the heat source 95 is external to the skate 10. For instance, the heat source 95 may be an oven in which the skate 10 can be placed to heat up the foam 110. The heat source 95 may be any other suitable type of heat source in other embodiments.

The foam 110 of the expandable user-engaging structure 12 may thus be heated to an expansion temperature Tₑ causing it to expand. For example, in some embodiments, the expansion temperature Tₑ to which the foam 110 is heated may be at least 40° C., in some cases at least 50° C., in some cases at least 70° C., and in some cases at least 100° C. and/or may be no more than 230° C., in some cases no more than 200° C., in some cases no more than 180° C., in some cases no more than 150° C., in some cases no more than 130° C., and in some cases no more than 110° C.

The expansion temperature Tₑ to which the foam 110 is heated may have any other suitable value in other embodiments.

The expandable user-engaging structure 12 thus expands from its initial shape Sᵢ, with the thickness Dᵢ, to its expanded shape Sₑ, with the thickness Dₑ.

At step 1020, the expandable user-engaging structure 12 of the liner 36 interfaces with the player's foot 11 in order to conform to the player's foot 11, thereby acquiring a final shape S_{f}, which may correspond to or be different from (e.g., smaller than) its expanded shape Sₑ.

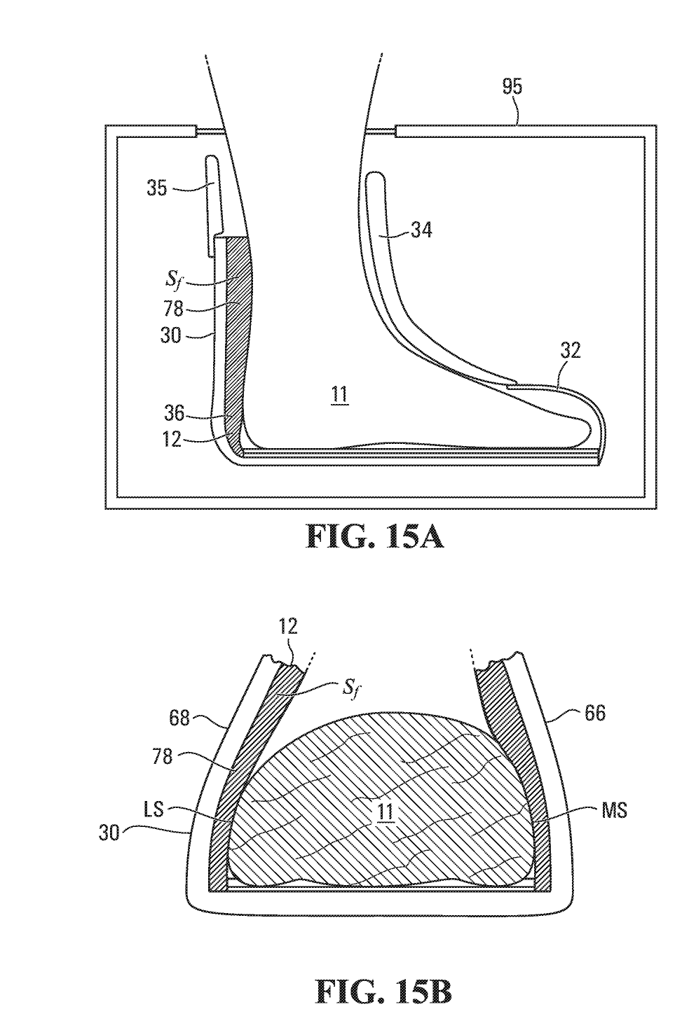

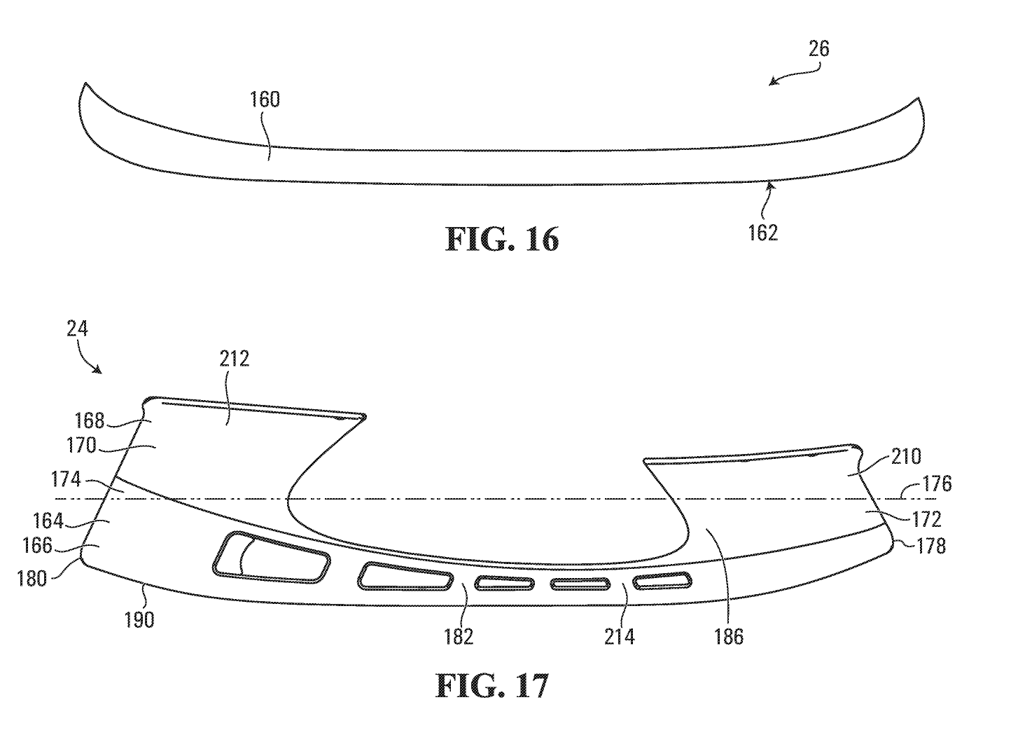

In some embodiments, as shown in FIG. 15A, the player's foot 11 may be in the skate 10 while the expansion of the expandable user-engaging structure 12 occurs. For instance, in this case, the player's foot 11 may be in the skate 10 while the skate 10 is heated in an oven. This may be done when the expansion temperature Tₑ for expanding the expandable material 106 is comfortable for the player's foot 11.

The expansion of the expandable user-engaging structure 12 occurs around the player's foot 11 until the expandable user-engaging structure 12 engages the player's foot 11. In this case, the expanded shape Sₑ of the expandable user-engaging structure 12 corresponds to the final shape S_{f} of the expandable user-engaging structure 12.

In other embodiments, the player's foot 11 may be placed in the skate 10 after the expansion of the expandable user-engaging structure 12 has occurred. For instance, the expansion of the expandable user-engaging structure 12 may occur in the oven 95 and then, once its expansion has stopped (e.g., the skate 10 is removed from the oven 95), the player's foot 11 is placed in the skate 10 such as to engage the expandable user-engaging structure 12. The expandable user-engaging structure 12 deforms in response to contacting the player's foot 11. For example, the expandable user-engaging structure 12 may be compressed where it is engaged by the player's foot 11. In such a case, the final shape S_{f} of the expandable user-engaging structure 12 may be different from (e.g., smaller than) the expanded shape of the expandable user-engaging structure 12.

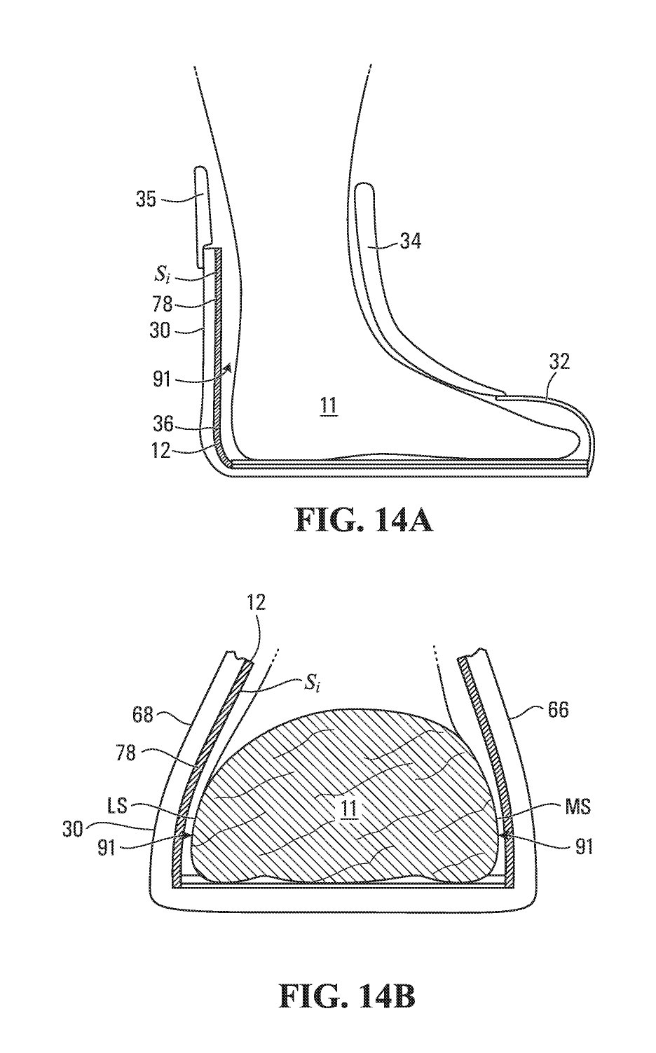

The expansion of the expandable user-engaging structure 12 may allow the skate 10 to provide a better fit to the player's foot 11. In particular, as shown in FIGS. 14A, 14B, 15A and 15B, the expansion of the expandable user-engaging structure 12 may reduce a void space 91 in the skate 10 between the player's foot 11 and the expandable user-engaging structure 12 such that the skate 10 has a better fit on the player's foot 11.

At step 1030, the expandable user-engaging structure 12 of the liner 36 is stabilized to retain its final shape S_{f}. For example, in this embodiment, the skate boot 22 is allowed to cool down to room temperature around the player's foot 11 to allow the foam 110 to stabilize. Once this is done, the player's foot 11 can be removed from the skate boot 22, with the expandable user-engaging structure 12 of the liner 36 retaining its final shape S_{f}.

This process may be performed at any suitable location. For example, in some embodiments, the expansion process of the expandable user-engaging structure 12 may be performed at a store or other establishment where the skate 10 is originally obtained by the player. That is, a retailer may offer to expand the expandable user-engaging structure 12 to fit the player's foot 11 at his/her business establishment. In such embodiments, the oven 95 may be a “skate oven” that is located at that store or other establishment.

As another example, in some embodiments, the expansion process of the expandable user-engaging structure 12 may be performed at an arena. For instance, the oven 95 may be located at the arena where the player may get the expandable user-engaging structure 12 of the skate 10 to be expanded as part of a service offered by the arena in a similar way that arenas offer to sharpen skates.

As another example, in some embodiments, the expansion process of the expandable user-engaging structure 12 may be performed at a residence of the player. For instance, the oven 95 may be a conventional oven (e.g., a kitchen oven) at the player's residence. In such embodiments, the player may place the skate 10 in the oven 95 himself/herself to cause the expansion process of the expandable user-engaging structure 12.

The blade 26 comprises an ice-contacting material 160 including an ice-contacting surface 162 for sliding on the ice surface while the player skates. In this embodiment, the ice-contacting material 160 is a metallic material (e.g., stainless steel). The ice-contacting material 162 may be any other suitable material in other embodiments.

The blade holder 24 comprises a lower portion 164 comprising a blade-retaining base 166 that retains the blade 26 and an upper portion 168 comprising a support 170 that extends upwardly from the blade-retaining base 166 towards the skate boot 22 to interconnect the blade holder 24 and the skate boot 22. A front portion 172 of the blade holder 24 and a rear portion 174 of the blade holder 24 define a longitudinal axis 176 of the blade holder 24. The front portion 172 of the blade holder 24 includes a frontmost point 178 of the blade holder 24 and extends beneath and along the player's forefoot in use, while the rear portion 174 of the blade holder 24 includes a rearmost point 180 of the blade holder 24 and extends beneath and along the player's hindfoot in use. An intermediate portion 182 of the blade holder 24 is between the front and rear portion 172, 174 of the blade holder 24 and extends beneath and along the player's midfoot in use. The blade holder 24 comprises a medial side 184 and a lateral side 186 that are opposite one another.

The blade-retaining base 166 is elongated in the longitudinal direction of the blade holder 24 and is configured to retain the blade 26 such that the blade 26 extends along a bottom portion 188 of the blade-retaining base 164 to contact the ice surface. To that end, the blade-retaining base 166 comprises a blade-retention portion 190 to face and retain the blade 26. In this embodiment, the blade-retention portion 190 comprises a recess 192 in which an upper portion of the blade 26 is disposed.

The blade holder 24 can retain the blade 26 in any suitable way in various embodiments.

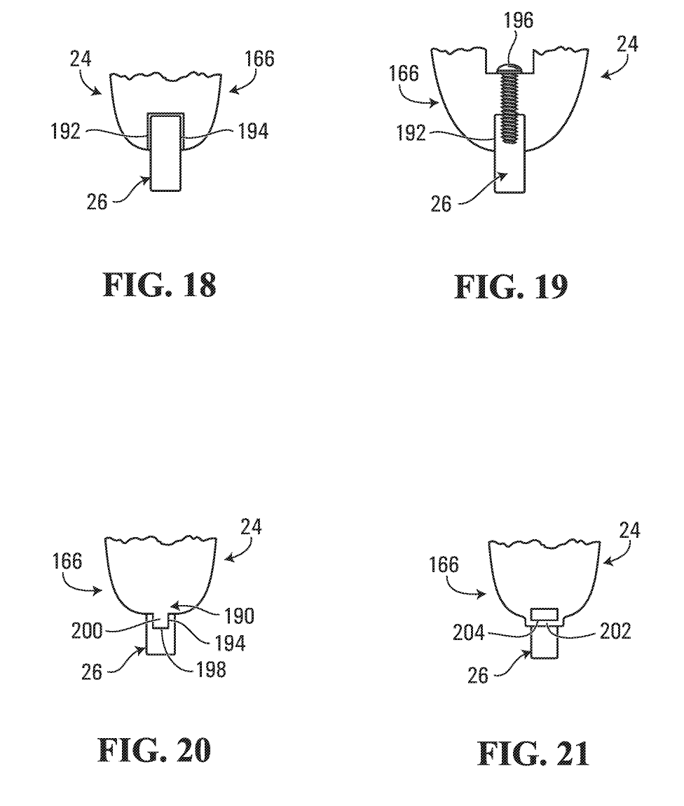

For instance, in some embodiments, the blade 26 may be permanently affixed to the blade holder 24 (i.e., not intended to be detached and removed from the blade holder 24). As an example, in some embodiments, as shown in FIGS. 18 and 19, the blade holder 24 may retain the blade 26 using an adhesive 194 and/or one or more fasteners 196. For instance, in some embodiments, as shown in FIG. 18, the recess 192 of the blade holder 24 may receive the upper part of the blade 26 that is retained by the adhesive 194. The adhesive 194 may be an epoxy-based adhesive, a polyurethane-based adhesive, or any suitable adhesive. In some embodiments, instead of or in addition to using an adhesive, as shown in FIG. 19, the recess 192 of the blade holder 24 may receive the upper part of the blade 26 that is retained by the one or more fasteners 196. Each fastener 196 may be a rivet, a screw, a bolt, or any other suitable mechanical fastener. Alternatively or additionally, in some embodiments, as shown in FIG. 20, the blade-retention portion 190 of the blade holder 24 may extend into a recess 198 of the upper part of the blade 26 to retain the blade 26 using the adhesive 194 and/or the one or more fasteners 196. For instance, in some cases, the blade-retention portion 190 of the blade holder 24 may comprise a projection 200 extending into the recess 198 of the blade 26. As another example, in some embodiments, as shown in FIG. 21, the blade 26 and the blade-retaining base 166 of the blade holder 24 may be mechanically interlocked via an interlocking portion 202 of one of the blade-retaining base 166 and the blade 26 that extends into an interlocking void 204 of the other one of the blade-retaining base 166 and the blade 26. For instance, in some cases, the blade 26 can be positioned in a mold used for molding the blade holder 24 such that, during molding, the interlocking portion 202 of the blade-retaining base 166 flows into the interlocking void 204 of the blade 26 (i.e., the blade holder 24 is overmolded onto the blade 26).

The support 170 is configured for supporting the skate boot 22 above the blade-retaining base 166 and transmit forces to and from the blade-retaining base 166 during skating. In this embodiment, the support 170 comprises a front pillar 210 and a rear pillar 212 which extend upwardly from the blade-retaining base 166 towards the skate boot 22. The front pillar 210 extends towards a front portion of the skate boot 22 and the rear pillar 212 extends towards a rear portion of the skate boot 22. The blade-retaining base 166 extends from the front pillar 210 to the rear pillar 212. More particularly, in this embodiment, the blade-retaining base 166 comprises a bridge 214 interconnecting the front and rear pillars 210, 212.

The skate 10, including the expandable user-engaging structure 12, may be implemented in various other ways in other embodiments.

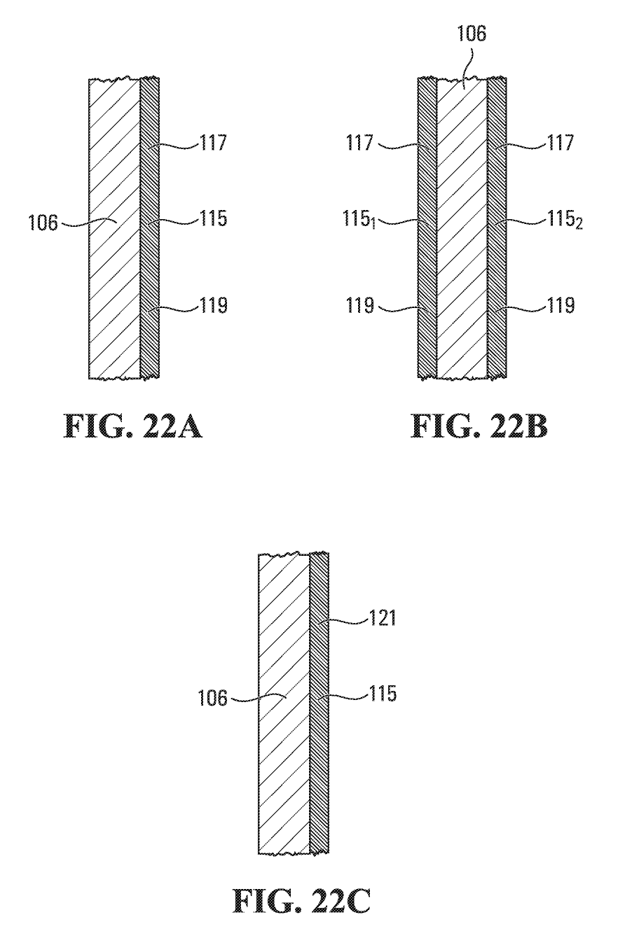

For example, in some embodiments, as shown in FIG. 22A, the expandable user-engaging structure 12 may comprise a lining 115 that overlies the expandable material 106 and includes at least part of the user-engaging surface 75 such that the lining 115 contacts the player's foot 11 when the skate 10 is worn.

For instance, in some embodiments, the lining 115 may enhance comfort. For example, the lining 115 may include a fabric 117 (e.g., a fabric made of NYLON® fibers or any other suitable fabric). Moreover, the lining 115 may be deformable (e.g., stretchable) to accommodate expansion of the expandable material 106. That is, the lining 115 may be configured to stretch when the expandable material 106 of the expandable user-engaging structure 12 expands. To that end, the lining 115 may comprise an elastic material 119 which may be a stretchable material (e.g., may include spandex).

The lining 115 may be affixed to the expandable material 106 in various ways. For example, the lining 115 may be affixed to the expandable material 106 via an adhesive and/or via one or more mechanical fasteners (e.g., stitching). The lining 115 may be affixed to the expandable material 106 in any other suitable way in other embodiments (e.g., via ultrasonic welding).

In some embodiments, as shown in FIG. 22B, the lining 115 may comprise lining layers 115₁, 115₂ that overly opposite sides of the expandable material 106. In such embodiments, one of the lining layers 115₁, 115₂ includes at least part of the user-engaging surface 75 and contacts the player's foot 11 when the skate 10 is worn, while the other one of the lining layers 115₁, 115₂ faces the shell 30.

In some embodiments, as shown in FIG. 22C, the lining 115 may enhance stiffness characteristics of the expandable user-engaging structure 12. For instance, in such embodiments, the lining 115 may comprise a material 121 that is stiffer than the expandable material 106 of the expandable user-engaging structure 12. For example, a ratio of a modulus of elasticity (e.g., Young's modulus) of the material 121 of the lining 115 over a modulus of elasticity of the expandable material 106 may be at least 1.1, in some cases at least 1.2, in some cases at least 1.5, in some cases at least 2, and in some cases even more.

For instance, in some cases where the material 121 of the lining 115 is stiffer than the expandable material 106, the lining 115 may be affixed to the expandable user-engaging structure 12 after it has expanded (i.e., in its expanded shape Sₑ). For example, the lining 115 may be molded onto the expandable user-engaging structure 12 after the expandable user-engaging structure 12 has acquired its expanded shape Sₑ.

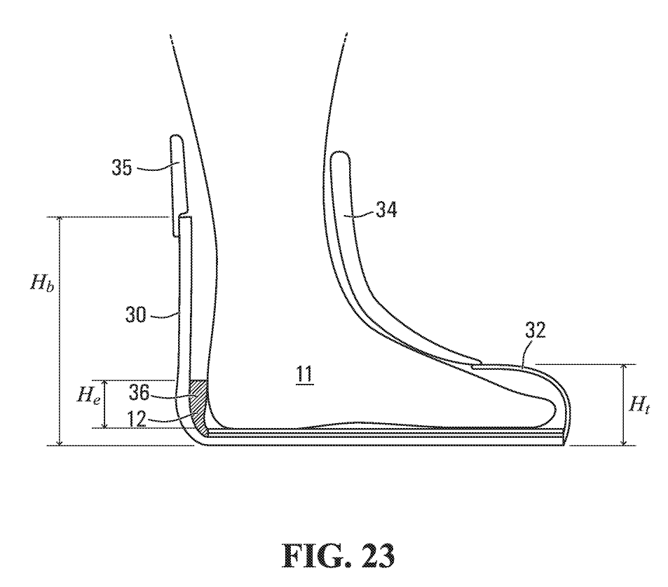

As another example, the expandable user-engaging structure 12 may extend so as to engage any desired part of the player's foot 11. For instance, in some embodiments, as shown in FIG. 23, the expandable user-engaging structure 12 may extend over less than a height H_{b} of the shell 30 of the skate boot 22. Thus, for example, a height Hₑ of the expandable user-engaging structure 12 may be no more than half, in some cases no more than one-third, and in some cases no more than one-quarter of the height H_{b} of the shell 30 of the skate boot 22. For instance, in some embodiments, the height Hₑ of the expandable user-engaging structure 12 may be no more than a height Hₜ of the toe cap 32.

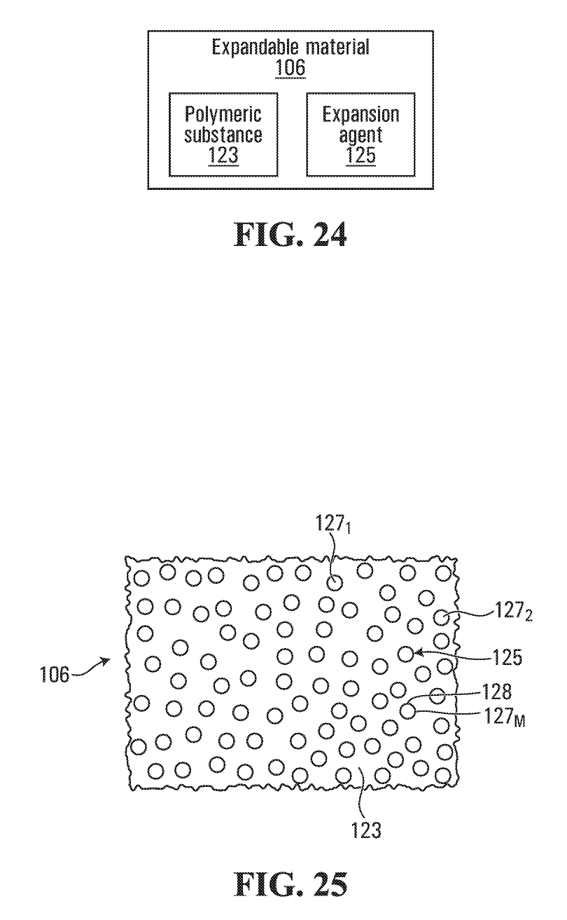

As another example, in some embodiments, as shown in FIGS. 24 and 25, the expandable material 106 may include a mixture of a polymeric substance 123 and an expansion agent 125 that allows the expandable material 106 to expand.

The polymeric substance 123 constitutes a substantial part of the expandable material 106 and substantially contributes to the structural integrity of the expandable material 106. For instance, in some embodiments, the polymeric substance 52 may constitute at least 40%, in some cases at least 50%, in some cases at least 60%, in some cases at least 70%, in some cases at least 80%, and in some cases at least 90% of the expandable material 106 by weight. In this example of implementation, the polymeric substance 123 may constitute between 50% and 80% of the expandable material 106 by weight.

In this embodiment, the polymeric substance 123 comprises polyurethane. The polyurethane 123 may be composed of any suitable constituents such as isocyanates and polyols and possibly additives. For instance, in some examples, the polyurethane 123 may be polyether or polyester. The polyurethane 123 may be an aromatic compound or an aliphatic compound. The polymeric substance 123 may comprise any other suitable polymer in other embodiments. For example, in some embodiments, the polymeric substance 123 may comprise silicon, rubber, latex, a thermoplastic elastomeric (TPE) or a thermoset.

The expansion agent 125 is combined with the polyurethane 123 to enable expansion of the expandable material 106. For instance, in some embodiments, the expansion agent 125 may constitute at least 5%, in some cases at least 10%, in some cases at least 20%, in some cases at least 30%, and in some cases at least 50% of the expandable material 106 by weight. In this example of implementation, the expansion agent 125 may constitute between 20% and 50% of the expandable material 106 by weight.

In this embodiment, the expansion agent 125 is activated via heat to which the skate 10 is subjected to when expanding the expandable user-engaging structure 12. An amount of energy (e.g., a heat) required to activate the expansion agent 125 is greater than an amount of energy (e.g., a heat) that the skate boot 22 of the skate 10 is subjected to during its manufacturing process. This can ensure that the expandable user-engaging structure 12 does not expand during the manufacturing process of the skate 10.

In this embodiment, the expansion agent 125 comprises an amount of expandable microspheres 127₁-127_{M}. Each expandable microsphere 127ᵢ comprises a polymeric shell 128 expandable by a fluid encapsulated in an interior of the polymeric shell 128. In this example of implementation, the polymeric shell 128 of the expandable microsphere 127ᵢ is a thermoplastic shell. The fluid encapsulated in the polymeric shell 128 is a liquid or gas (in this case a gas) able to expand the expandable microsphere 127ᵢ when heated. In this embodiment, the expandable microspheres 127₁-127_{M} are Expancel™ microspheres commercialized by Akzo Nobel. Various other types of expandable microspheres may be used in other embodiments.

In this example of implementation, the expandable microspheres 127₁-127_{M} include dry unexpanded (DU) microspheres when combined with the polymeric substance 123 to create the expandable material 106. For instance, the dry unexpanded (DU) microspheres may be provided as a powder mixed with one or more liquid constituents of the polymeric substance 123.

Thus, in this embodiment, when the skate 10, including the expandable user-engaging structure 12, is heated such as to reach the temperature Tₑ, the expandable material 106 of the expandable user-engaging structure 12 expands. In particular, the fluid encapsulated within the polymeric shell 128 of each expandable microsphere 127ᵢ of the expansion agent 125 expands in reaction to the heat to which the skate 10 is subjected, causing the polymeric shell 128 of the expandable microsphere 127ᵢ to stretch which in turn causes an enlargement of the expandable microsphere 127ᵢ.

In some embodiments, the expandable material 106 may be made via reaction injection molding (i.e., injection molding using a thermosetting polymer) rather than mixing a polymer with an expansion agent.

As another example, in some embodiments, the expandable user-engaging structure 12 may comprise a plurality of different expandable materials 206₁-206_{E} such as the expandable material 106.

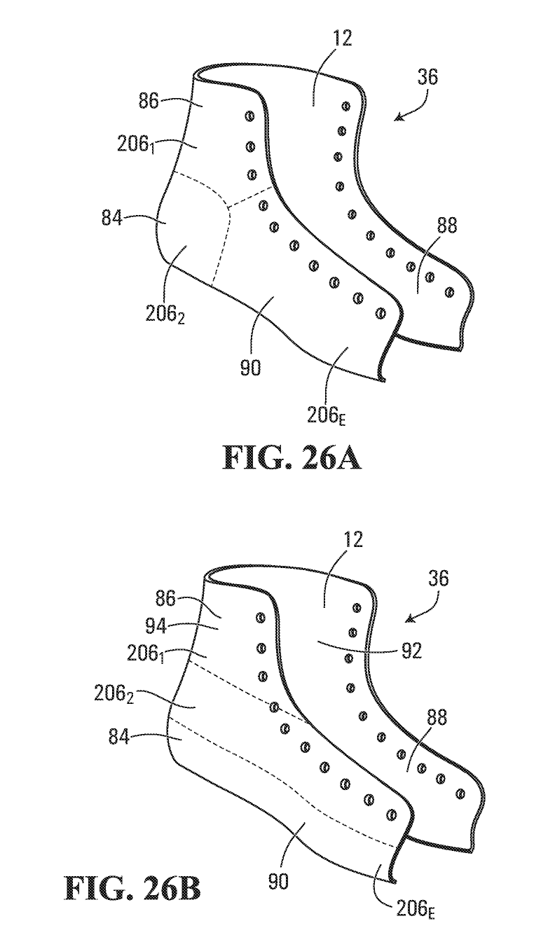

As shown in FIGS. 26A and 26B, respective ones of the expandable materials 206₁-206_{E} may be arranged to overlie different regions of the player's foot 11. For instance, respective ones of the expandable materials 206₁-206_{E} may be disposed at the heel portion 84, the ankle portion 86, and at the medial and lateral side portions 88, 90 of the expandable user-engaging structure 12. For example, a stiffer or harder expandable material 206ᵢ may be disposed at a portion of the expandable user-engaging structure 12 where strength is preferred, and a less stiff or softer expandable material 206ⱼ may be disposed at a portion of the expandable user-engaging structure 12 where comfort is preferred. For instance, in the example shown in FIG. 26B, the expandable materials 206₁-206_{E} of the expandable user-engaging structure 12 are distributed along the heightwise direction of the skate 10. In other examples, the expandable materials 206₁-206_{E} may be distributed along the longitudinal direction of the skate 10. In yet other examples, the expandable materials 206₁-206_{E} may be distributed along the heightwise and the longitudinal directions of the skate 10.

A given expandable material 206ᵢ may be more expandable than another expandable material 206ⱼ. That is, the given expandable material 206ᵢ may be able to expand more in response to the heat or other stimulus to which the skate 10 is subjected. For instance, a ratio of an expandability of the expandable material 206ᵢ over an expandability of the expandable material 206ⱼ may be at least 1.1, in some cases at least 1.2, in some cases at least 1.5, in some cases at least 2 and in some cases even more.

In some embodiments, a given expandable material 206ᵢ may be denser than another expandable material 206ⱼ. For instance, a ratio of a density of the expandable material 206ᵢ over a density of the expandable material 206ⱼ may be at least 1.1, in some cases at least 1.2, in some cases at least 1.5, in some cases at least 2 and in some cases even more.

Moreover, in some embodiments, a given expandable material 206ᵢ may be stiffer than another expandable material 206ⱼ. For instance, a ratio of a modulus of elasticity (e.g., Young's modulus) of the expandable material 206ᵢ over a modulus of elasticity of the expandable material 206ⱼ may be at least 1.1, in some cases at least 1.2, in some cases at least 1.5, in some cases at least 2 and in some cases even more.

In this embodiment, different ones of the expandable materials 206₁-206_{E} include different foams.

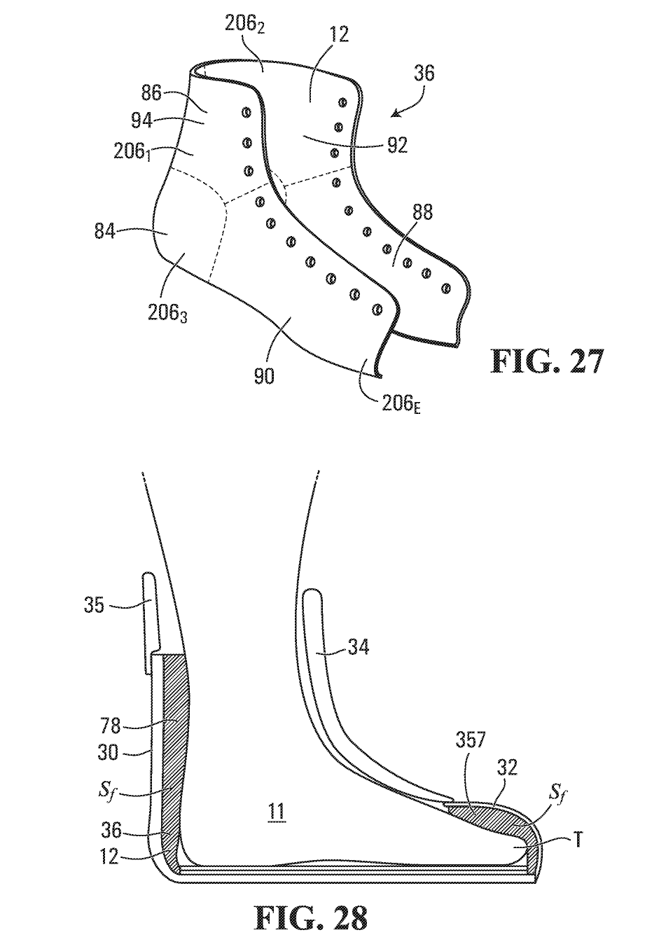

In a variant, two or more of the expandable materials 206₁-206_{E} may overlap. That is, two or more of the expandable materials 206₁-206_{E} may overlie a common region of the player's foot 11. For example, as shown in FIG. 27, the expandable materials 206₁, 206₂ may be disposed at the ankle portion 86 of the expandable user-engaging structure 12 such as to overlie the player's ankle A. In particular, in this example, the expandable material 206₁ is disposed at the lateral ankle side 94 of the ankle portion 86 and the expandable material 206₂ is disposed at the medial ankle side 92 of the ankle portion of the expandable user-engaging structure 12. Such a configuration of the expandable materials 206₁-206_{E} may allow a given one of the medial and lateral ankle sides 92, 94 of the ankle portion 86 to be stiffer, denser and/or more expandable (i.e., have a higher expandability ratio) than the other of the medial and lateral ankle sides 92, 94 of the ankle portion 86 of the expandable user-engaging structure 12.

While FIGS. 26A, 26B and 27 illustrate the expandable materials 206₁-206_{E} as being separated by a dashed line, this is solely for illustration purposes and a physical demarcation between the expandable materials 206₁-206_{E} may not actually be visible. In particular, such a physical demarcation between the expandable materials 206₁-206_{E} may be avoided by molding the expandable materials 206₁-206_{E} together when molding the expandable user-engaging structure 12 to have its initial shape Sᵢ.

As another example, in some embodiments, the expandable user-engaging structure 12 may comprise different portions that engage different regions of the player's foot 11. For instance, the expandable user-engaging structure 12 may comprise additional portions such as a toe portion, a sole portion, a tongue portion, etc. For example, these different portions may comprise respective parts of the expandable material 106.

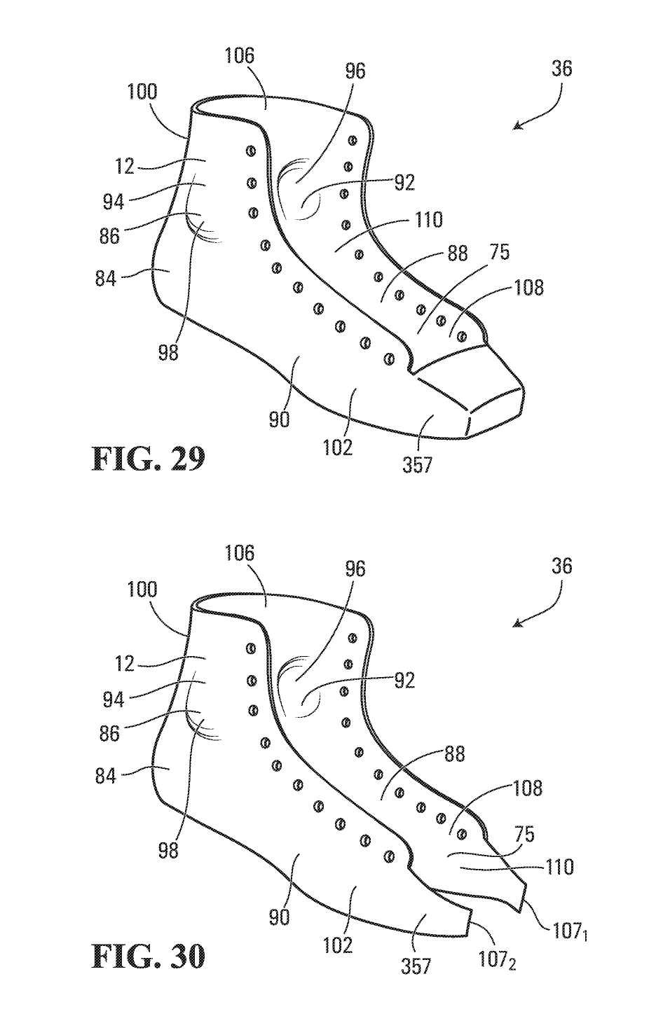

For instance, in some embodiments, as shown in FIGS. 28 to 31, the expandable user-engaging structure 12 may comprise a toe portion 357 overlying the toes T of the player's foot 11 to allow the fit of the skate boot 22 to be better in a toe area of the skate boot 22. In some examples, as shown in FIG. 30, the toe portion 357 of the expandable user-engaging structure 12 comprises medial and lateral extensions 107₁, 107₂ of the liner 36 that extend into the toe cap 32 along at least part of a length of the toe cap 32 (e.g., a majority or an entirety of the length of the toe cap 32).

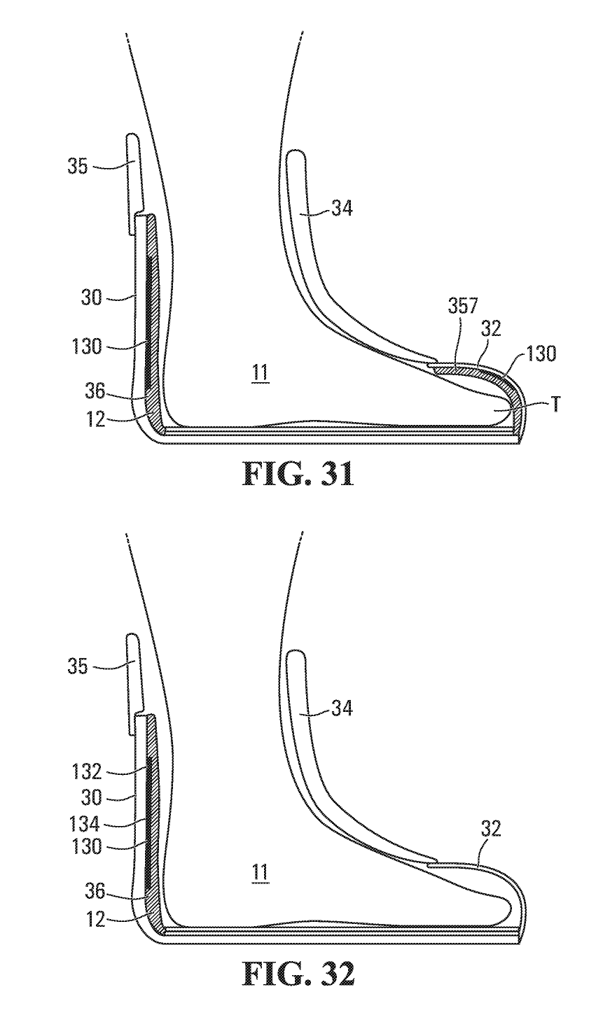

As another example, in some embodiments, as shown in FIGS. 31, 32 33, the skate 10 may comprise a heater 130 for generating heat to expand the expandable user-engaging structure 12. In other words, the heater 130 implements the heat source 95 in those embodiments.

The heater 130 may comprise a heating element 132 to generate heat that is transferred to the expandable user-engaging structure 12. For instance, the heating element 132 may be an electrical heating element such as a wire 134 that generates heat in response to an electrical current. The wire 134 may be adjacent to the expandable user-engaging structure 12 (e.g., disposed between the shell 30 and the user-engaging structure 12). In other embodiments, the wire 134 may be internal to the user-engaging structure 12 (e.g., embedded in the expandable material 106).

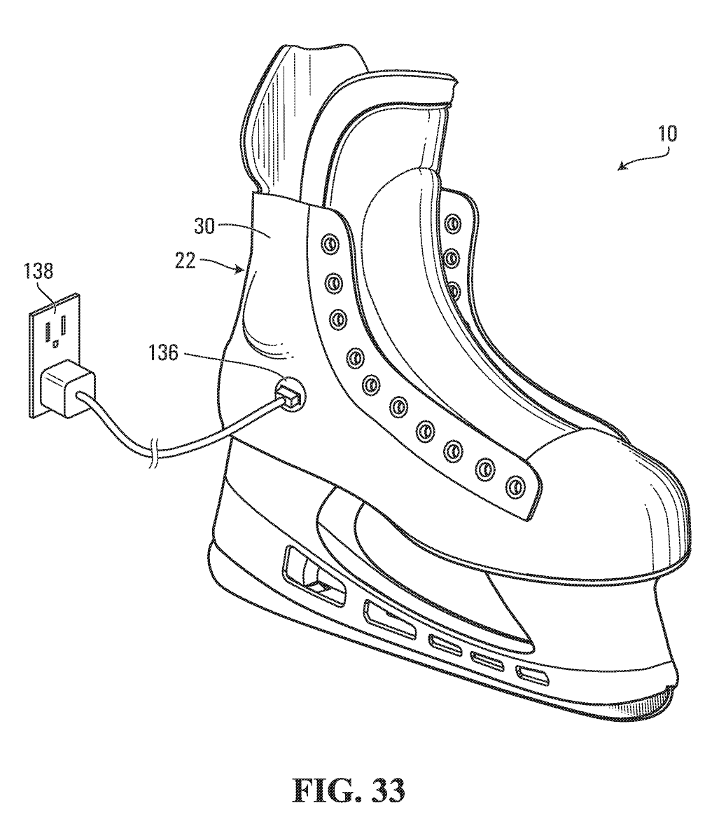

The heater 130 comprises an electrical connector 136 to electrically connect the electrical heating element 134 to an external electrical power source 138 (e.g., an electrical wall outlet, a battery such as an AC or DC battery, etc.). As shown in FIG. 33, the electrical connector 136 may be located on an outer surface of the shell 30 such as to be connectable to the external electrical power source 138 directly from the outer surface 28 of the skate boot 22. In such a case, the electrical connector 136 basically traverses the shell 30 such as to establish a connection with the electrical heating element 134. An external connector 140 (e.g., a cable) can be used to connect the electrical connector 136 of the heater 130 of the skate 10 to the external electrical power source 138. Moreover, the electrical connector 136 may comprise any suitable type of terminal (e.g., a socket terminal, a USB terminal, etc.).

The electrical connector 136 may be configured in any other suitable way. For instance, in some embodiments, the electrical connector 136 may be disposed at a different portion of the skate 10. For example, in some cases, rather than being positioned on the outer surface of the shell 30, the electrical connector 136 may be positioned on an outer surface of the outsole 42 such that the skate 10 is connectable from an underside of the skate boot 22.

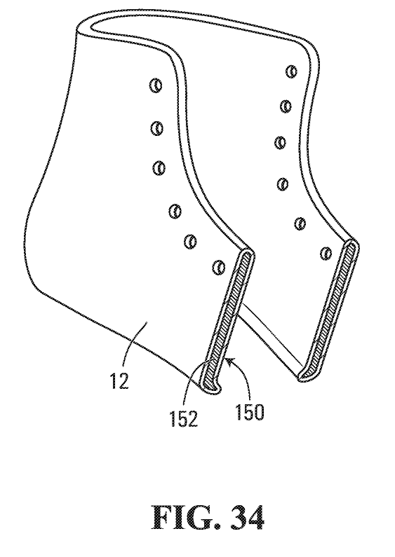

As another example, in some embodiments, as shown in FIG. 34, the expandable user-engaging structure 12 may comprise a container 150 to receive a filling material 152 to expand the expandable user-engaging structure 12. That is, the addition of the filling material 152 into the container 150 causes expansion of the container 150 of the expandable user-engaging structure 12.

The filling material 152 may be injected into the container 150 of the expandable user-engaging structure 12. For instance, the filling material 152 may be a liquid or solid (e.g., gel, etc.) that is injectable into the container 150 of the expandable user-engaging structure 12. In some embodiments, the filling material 152 may be configured to solidify in the container 150 after being injected therein. That is, the filling material 152 may be in a liquid or soft state at the time of injection into the container 150 but may solidify or rigidify, i.e., become a solid or rigid substance, after a given amount of time. In other embodiments, the filling material 152 may remain in a liquid or soft state in the container 150. In one example, the filling material 152 may be a hydrogel.

The container 150 comprises an enveloping material 154 within which the filling material 152 may be contained. The enveloping material 154 may be a flexible material which allows the container 150 to stretch when the filling material 152 is injected therein. For instance, the container 150 may be a flexible pouch having dimensions that adjust (e.g., expand) in accordance to an amount of the filling material 152 that is contained within the flexible pouch.

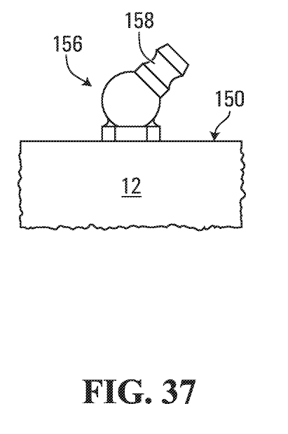

The filling material 152 may be injected into the container 150 via a port 156 of the expandable user-engaging structure 12. The port 156 may be selectively sealable to allow more than a single injection of the material 152 into the container 150. For example, as shown in FIG. 37, the port 156 may comprise a nipple 158 comprising an opening for injecting therein the material 152 and a cover (not shown) for sealing the nipple 158. Moreover, the port 156 may be disposed at a portion of the expandable user-engaging structure 12 where its presence does not prevent or otherwise disturb wearing of the skate 10. For example, in some cases, the port 156 may be provided at a portion of the expandable user-engaging structure 12 of the liner 36 that does not overlap the shell 30 (e.g., at a portion overlapping the tendon guard 25 (not shown)).

The container 150 is affixed to the remainder of the skate boot 22. That is, the container 150 is not intended to be removable from the skate boot 22. To that end, the container 150 is fastened to the remainder of the skate boot 22 (e.g., the shell 30). For instance, the container 150 may be fastened to the remainder of the skate boot 22 via an adhesive, one or more mechanical fasteners, or in any other suitable way.

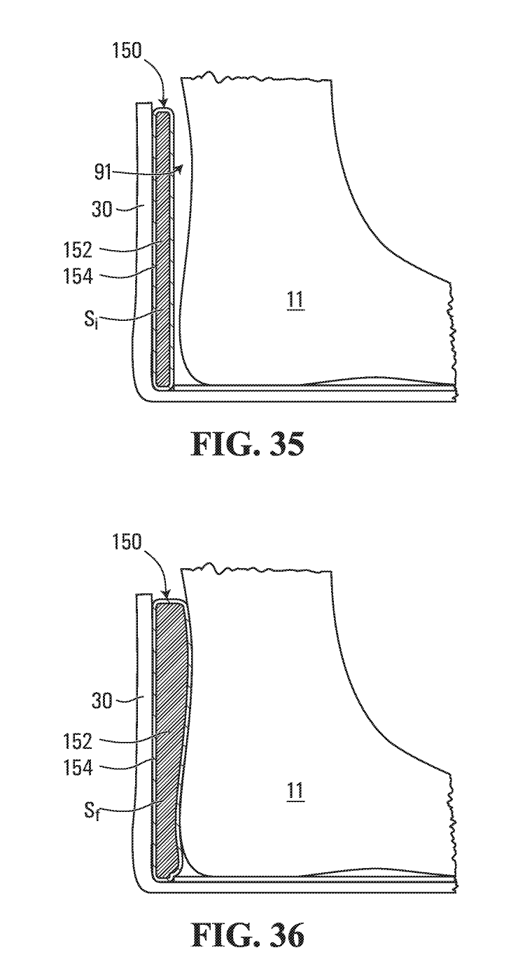

Thus, in embodiments where the expandable user-engaging structure 12 comprises the container 150, in order to conform the expandable user-engaging structure 12 to the player's foot 11 or to otherwise improve the fit of the skate 10 on the player's foot 11, the player first places his/her foot 11 in the skate 10. The container 150 is then filled with the filling material 152 such as to cause expansion of the container 150 of the expandable user-engaging structure 12. As the container 150 expands from its initial shape Sᵢ to its final shape S_{f} (which may correspond to its expanded shape Sₑ), as shown in FIGS. 35 and 36, the container 150 may at least in part fill the void space 91 between the player's foot 11 and the skate boot 22 such as to improve the fit of the skate 10 on the player's foot 11.

As another example, in some embodiments, the stimulus in respect to which the expandable user-engaging structure 12 is expanded may be other than heat. For instance, in some embodiments, the stimulus that causes the expandable user-engaging structure 12 to expand may be microwaves. That is, the expandable material 106 of the expandable user-engaging structure 12 can be made to expand by subjecting it to microwave radiation. In some cases, the expansion of the expandable user-engaging structure 12 via microwave radiation may be facilitated by exposing the expandable user-engaging structure 12 to water. However, exposure to water is not necessary for expanding the expandable user-engaging structure 12 via microwave radiation.

As another example, in some embodiments, the blade holder 24 may retain the blade 26 in any other suitable way. For example, in other embodiments, the blade holder 24 comprises a blade-detachment mechanism 218 such that the blade 26 is selectively detachable and removable from, and attachable to, the blade holder 24 (e.g., when the blade 26 is worn out or otherwise needs to be replaced or removed from the blade holder 24).

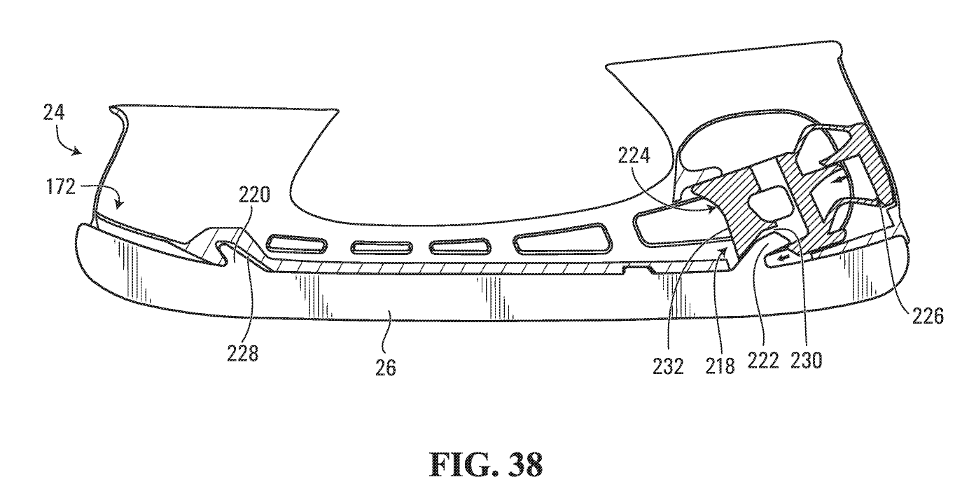

More particularly, with additional reference to FIG. 38, in this embodiment, the blade 26 includes a plurality of projections 220, 222. The blade-detachment mechanism 218 includes an actuator 224 and a biasing element 226 which biases the actuator 224 in a direction towards the front portion 172 of the blade holder 24. In this embodiment, the actuator 224 comprises a trigger. To attach the blade 26 to the blade holder 24, the front projection 220 is first positioned within a hollow space 228 (e.g., a recess or hole) of the blade holder 24. The rear projection 222 can then be pushed upwardly into a hollow space 230 (e.g., a recess or hole) of the blade holder 24, thereby causing the biasing element 226 to bend and the actuator 224 to move in a rearward direction. The rear projection 222 will eventually reach a position which will allow the biasing element 226 to force the actuator 224 towards the front portion 172 of the blade holder 24, thereby locking the blade 26 in place. The blade 26 can then be removed by pushing against a finger-actuating surface 232 of the actuator 224 to release the rear projection 222 from the hollow space 230 of the blade holder 24. Thus, in this embodiment, the blade-detachment mechanism 218 is free of any threaded fastener (e.g., a screw or bolt) to be manipulated to detach and remove the blade 26 from the blade holder 24 or to attach the blade 26 to the blade holder 24.

Further information on examples of implementation of the blade-detachment mechanism 218 in some embodiments may be obtained from U.S. Pat. No. 8,454,030 hereby incorporated by reference herein. The blade-detachment mechanism 218 may be configured in any other suitable way in other embodiments.

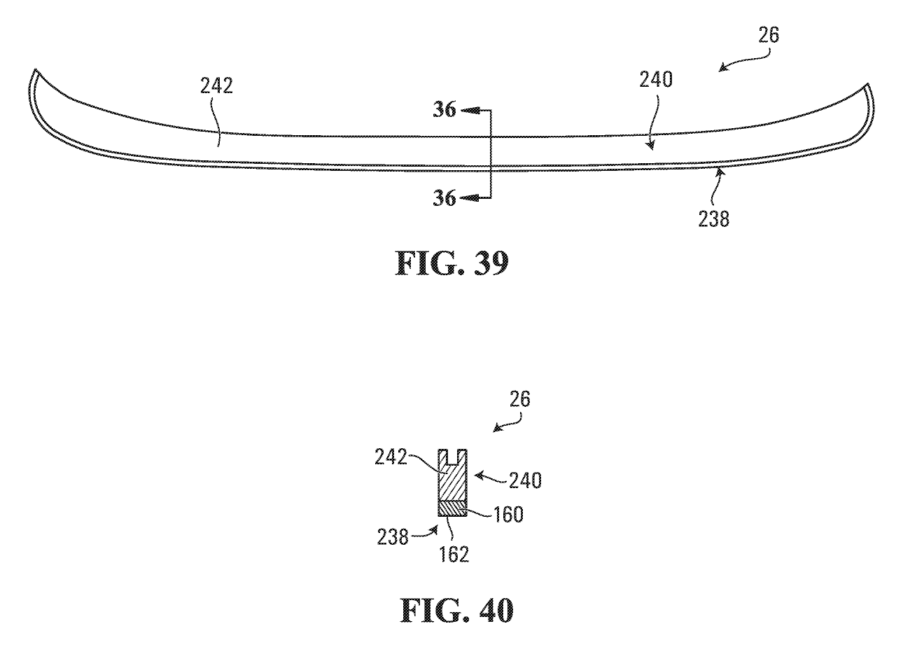

The blade 26 may be implemented in any other suitable way in other embodiments. For example, in some embodiments, as shown in FIGS. 39 and 40, the blade 26 may comprise a runner 238 that is made of the ice-contacting material 160 and includes the ice-contacting surface 162 and a body 240 connected to the runner 238 and made of a material 242 different from the ice-contacting material 160. The runner 238 and the body 240 of the blade 26 may be retained together in any suitable way. For example, in some cases, the runner 238 may be adhesively bonded to the body 240 using an adhesive. As another example, in addition to or instead of being adhesively bonded, the runner 238 and the body 240 may be fastened using one or more fasteners (e.g., rivets, screws, bolts, etc.). As yet another example, the runner 238 and the body 240 may be mechanically interlocked by an interlocking portion of one of the runner 238 and the body 240 that extends into an interlocking space (e.g., one or more holes, one or more recesses, and/or one or more other hollow areas) of the other one of the runner 238 and the body 240 (e.g., the body 240 may be overmolded onto the runner 238).

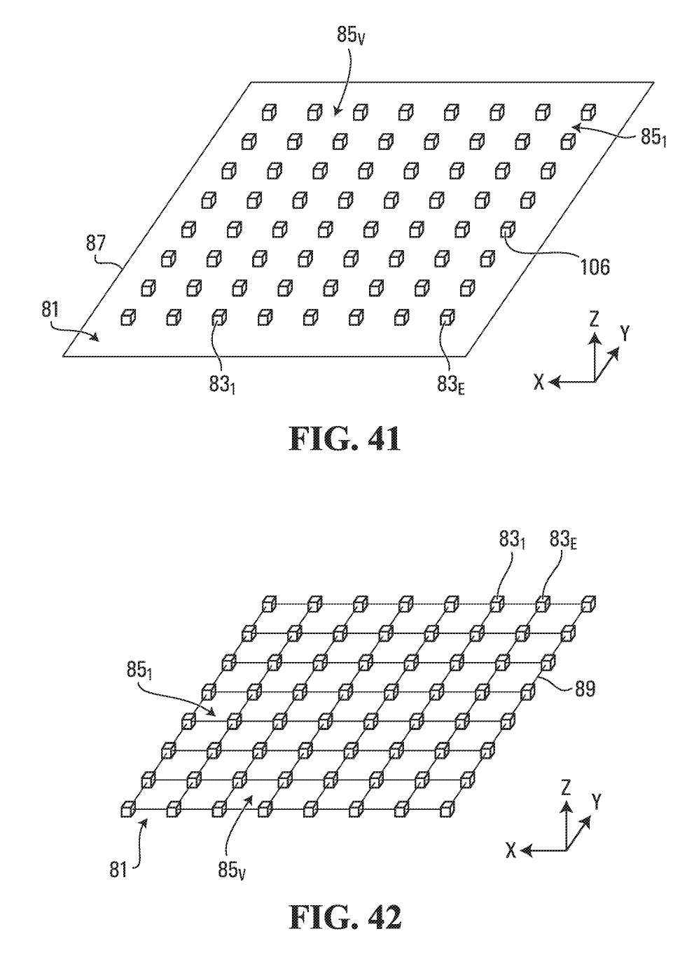

In a variant, the expandable user-engaging structure 12 may be configured to facilitate controlled expansion of its expandable material 106 in one or more directions. For instance, in one example of implementation, as shown in FIG. 41, the expandable user-engaging structure 12 comprises a retainer 81 and a plurality of expandable elements 83₁-83_{E} attached to the retainer 81. More particularly, the expandable elements 83₁-83_{E} are affixed on the retainer 81 such that the expandable elements 83₁-83_{E} are spaced apart from one another. In this case, the expandable elements 83₁-83_{E} are spaced apart from one another by voids 85₁-85_{V} disposed between the expandable elements 83₁-83_{E}. Each void 85ᵢ has a given surface area. A spacing between adjacent ones of the expandable elements 83₁-83_{E} may be uniform throughout an extent of the expandable user-engaging structure 12, or in some cases, the spacing between adjacent ones of the expandable elements 83₁-83_{E} may vary throughout the extent of the expandable user-engaging structure 12. In other words, the surface area of the voids 85₁-85_{V} may be the same for all the voids 85₁-85_{V} or, in other cases, the surface area of the voids 85₁-85_{V} may vary.

In this example, the retainer 81 comprises a lining 87 for facing the player's foot 11. The lining 87 may be similar to the lining 115 described above. Notably, the lining 87 may enhance comfort. For example, the lining 87 may include a fabric (e.g., a fabric made of NYLON® fibers or any other suitable fabric). Moreover, the lining 87 may be deformable (e.g., stretchable) to accommodate expansion of the expandable material 106 of the expandable user-engaging structure 12. That is, the lining 87 may be configured to stretch when the expandable material 106 of the expandable user-engaging structure 12 expands. To that end, the lining 87 may comprise an elastic material which may be a stretchable material (e.g., may include spandex).

In another example, as shown in FIG. 42, the retainer 81 may comprise a mesh 89 that comprises a plurality of elongated members (e.g., strands) interconnecting the expandable elements 83₁-83_{E}.

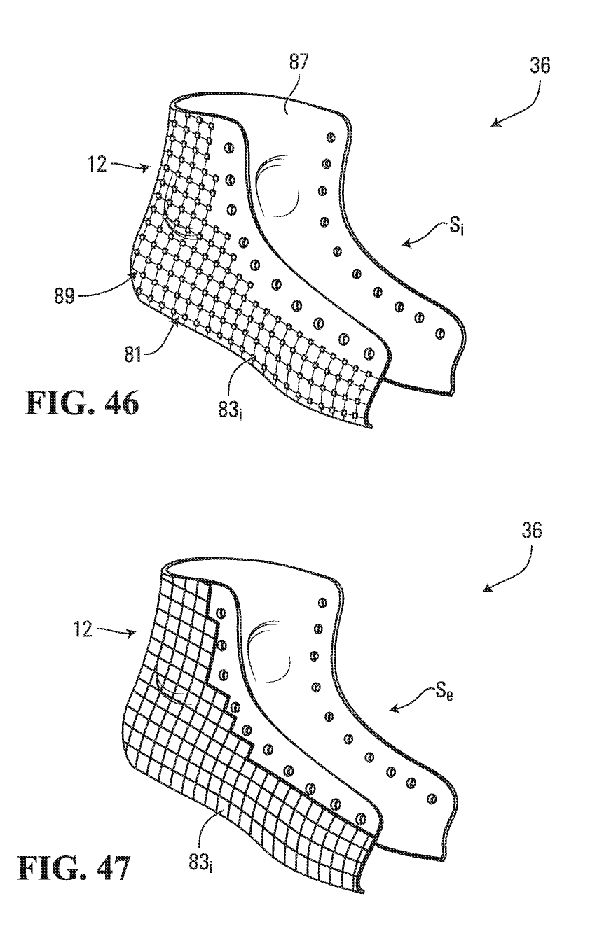

In another example, as shown in FIG. 46, the retainer 81 may comprise both the mesh 89 and the lining 87. That is, the expandable elements 83₁-83_{E} may be attached to the lining 87 and the mesh 89.

Each expandable element 83ᵢ comprises a portion of the expandable material 106 described above. In this example, the expandable element 83ᵢ is cubic. The expandable element 83ᵢ may have any other suitable shape in other cases (e.g., spherical). Furthermore, in this example, the expandable elements 83₁-83_{E} are molded onto the retainer 81. For instance, in examples where the retainer 81 comprises the lining 87, the expandable pieces 83₁-83_{E} may be molded onto a top surface of the lining 87. In other examples, for instance where the retainer 81 comprises the mesh 89, the expandable elements 83₁-83_{E} may be molded onto the mesh 89 such that the mesh 89 is embedded in the expandable elements 83₁-83_{E}.

Thus, in this variant, when the expandable user-engaging structure 12 is subjected to the stimulus to cause the expandable material 106 to expand, each expandable element 83ᵢ expands along various directions. More specifically, in this example, each expandable element 83ᵢ expands along three directions that are normal to one another, notably along a length direction, along a width direction and along a thickness direction of the retainer 81 (respectively denoted by an x-axis, a y-axis and a z-axis in FIGS. 41 and 42). Thus, the expandable elements 83₁-83_{E} of the expandable user-engaging structure 12 expand from the initial shape Sᵢ, as shown in FIG. 46, along the length, width and thickness directions of the retainer 81 to the expanded shape Sₑ of the expandable user-engaging structure 12, as shown in FIG. 47, such that the surface area of the voids 85₁-85_{V} shrinks and, more particularly, results in the expandable material 106 of the expandable elements 83₁-83_{E} occupying the surface area that was previously occupied by the voids 85₁-85_{V}.

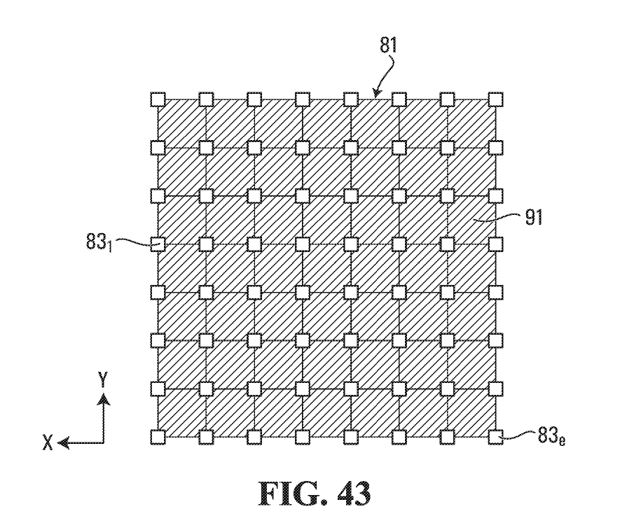

In another example, the expandable elements 83₁-83_{E} of the retainer 81 may not be spaced apart by voids. For instance, as shown in FIG. 43, the retainer 81 may comprise a filler 91 disposed between the expandable elements 83₁-83_{E}. The filler 91 comprises a compressible material to accommodate the expansion of the expandable elements 83₁-83_{E}. For example, the compressible material of the filler 91 may be a foam.

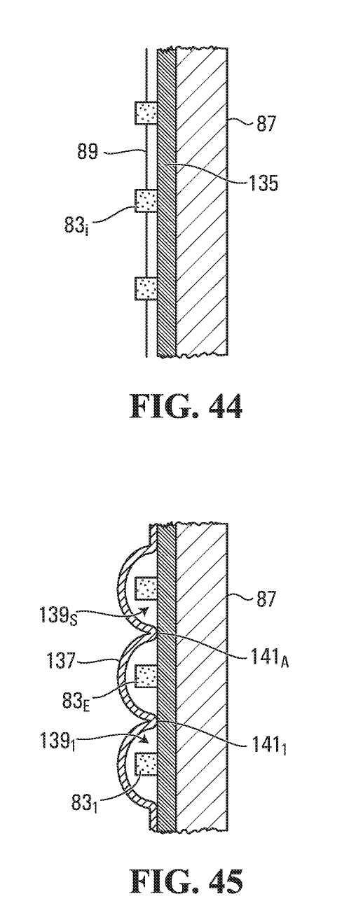

In another example, with additional reference to FIG. 44, the retainer 81 may comprise a low-friction layer 135 disposed between the expandable elements 83₁-83_{E} and the lining 87. The low-friction layer 135 has a relatively low coefficient of friction with the expandable elements 83₁-83_{E}. For instance, in some embodiments, the coefficient of friction of the low-friction layer 135 with the expandable elements 83₁-83_{E} may be no more than 0.5, in some cases no more than 0.4, in some cases no more than 0.3, in some cases no more than 0.2, in some cases no more than 0.1, and in some cases even less. For example, the low-friction layer 135 may comprise polytetrafluoroethylene (PTFE), fluorinated ethylene propylene (FEP), perfluoroalkoxy (PFA) or any other suitable low friction material. The presence of the layer 135 may facilitate expansion of the expandable material 106 of the expandable elements 83₁-83_{E} as it may more freely allow movement of the expandable material 106 along a surface of the layer 135.

In another example, with additional reference to FIG. 45, the retainer 81 may comprise a covering 137 that overlies the expandable elements 83₁-83_{E} and may be affixed to the lining 87 (or the layer 135 if present). More specifically, in this embodiment, the covering 137 is affixed to the lining 87 (or the layer 135) such as to define a plurality of internal spaces 139₁-139_{S} enclosed between the covering layer 137 and the lining 87 (or the layer 135). To that end, the covering 137 is affixed to the lining 87 (or the layer 135) at attachment portions 141₁-141_{A} of the covering 137 which define boundaries of each internal space 139ᵢ. For example, the covering 137 may be affixed to the lining 87 (or the layer 135) via ultrasonic welding or in any other suitable manner (e.g., stitching). Furthermore, an expandable element 83ᵢ is housed in each internal space 139ᵢ. Thus, when the expandable user-engaging structure 12 is subjected to the stimulus (e.g., heat), the expandable elements 83₁-83_{E} expand to fill their respective internal space 139ᵢ. Moreover, the covering 137 may be configured to contract when subjected to a stimulus such as heat such that a portion of the covering layer 137 between the expandable elements 83₁-83_{E} shrinks as the expandable elements 83₁-83_{E} expand.

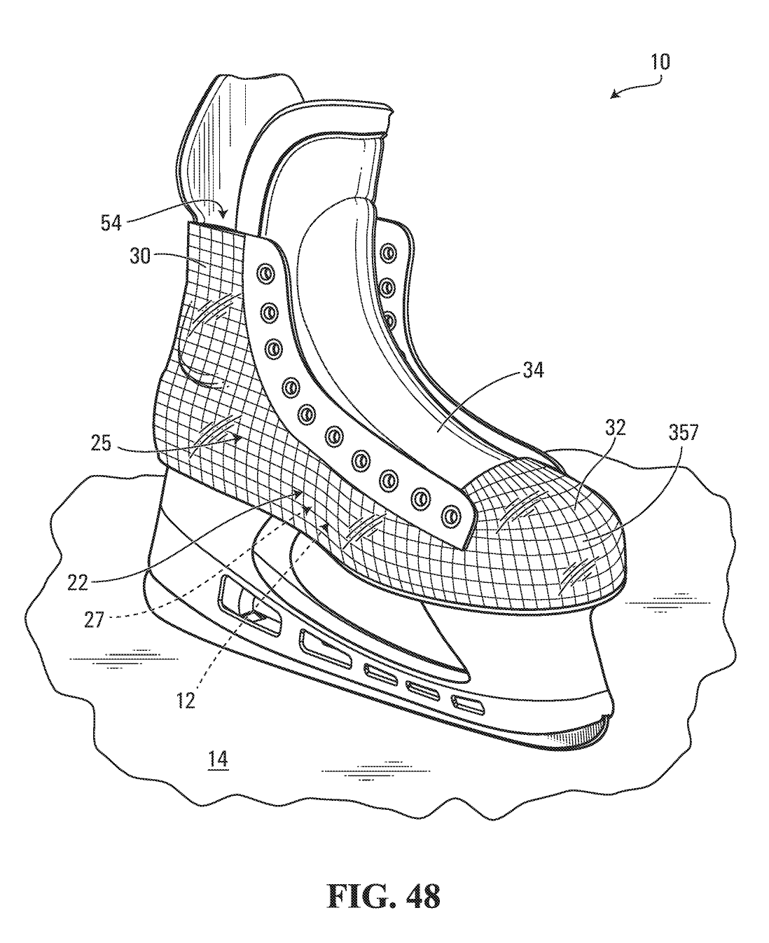

In a variant, in some embodiments, as shown in FIG. 48, the expandable user-engaging structure 12 comprises the toe portion 357 overlying the toes T of the player's foot 11, and, in this example, the skate 10 may not comprise the toe cap 32. For instance, the toe portion 357 of the expandable user-engaging structure 12 may act as the toe cap 32, provided that the toe portion 357 of the expandable user-engaging structure 12 is sufficiently stiff. In other examples, the toe portion 357 of the expandable user-engaging structure 12 may underlie the toe cap 32 such that the toe portion 357 of the expandable user-engaging structure 12 is disposed between the toe cap 32 and the toes T of the player's foot 11, similar to that shown in FIGS. 28 to 31.

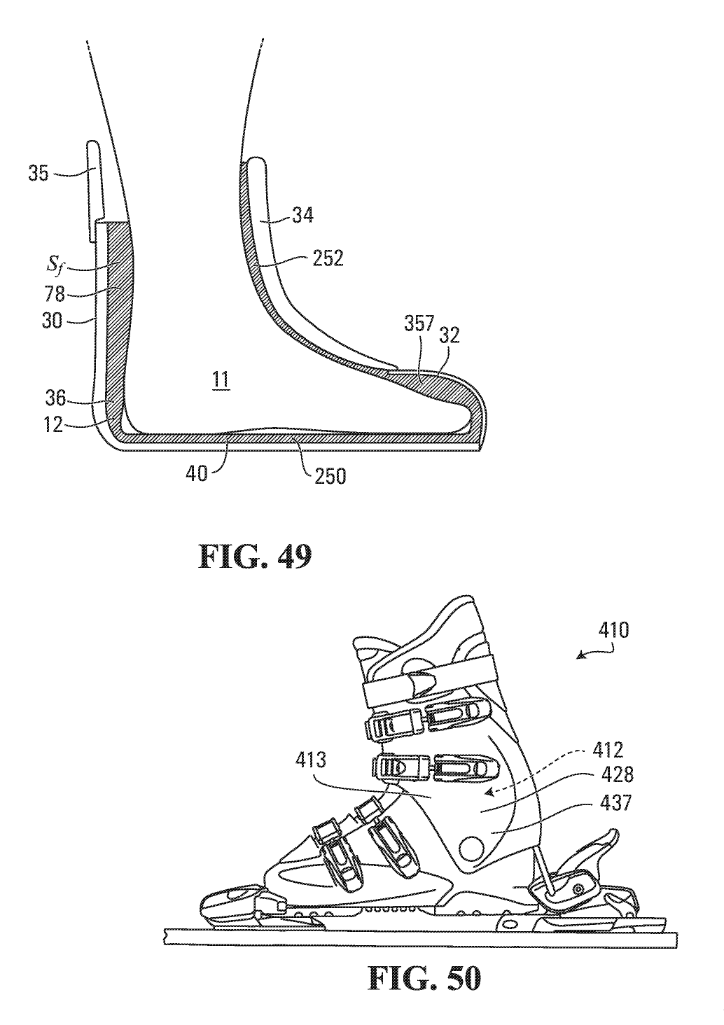

In a similar manner, the expandable user-engaging structure 12 may comprise a sole portion, a tongue portion, and/or other portions. For example, as shown in FIG. 49, the expandable user-engaging structure 12 may comprise a sole portion 250 that may be part of the insole 40 and/or the footbed 38. As another example, the expandable user-engaging structure 12 may comprise a tongue portion 252 that is part of the tongue 34 to engage an instep of the player's foot 11. For instance, the tongue portion 252 of the expandable user-engaging structure 12 may be affixed to a rear side of an outer layer of the tongue 34.

Furthermore, in the variant shown in FIG. 48, the shell 30 of the skate 10 is clear (i.e., translucent or transparent) to allow a user to view the expansion of the expandable user-engaging structure 12 from the exterior of the skate 10. For instance, in the example illustrated, the expandable user-engaging structure 12 comprises the retainer 81 such that the user is able to view the expansion of the expandable elements 83₁-83_{E} of the retainer 81.

Although in embodiments considered above the skate 10 is designed for playing ice hockey on the skating surface 14 which is ice, in other embodiments, the skate 10 may be constructed using principles described herein for playing roller hockey or another type of hockey (e.g., field or street hockey) on the skating surface 14 which is a dry surface (e.g., a polymeric, concrete, wooden, or turf playing surface or any other dry surface on which roller hockey or field or street hockey is played). Thus, in other embodiments, instead of comprising the blade 26, the skating device 23 may comprise a set of wheels to roll on the dry skating surface 14 (i.e., the skate 10 may be an inline skate or other roller skate).

While embodiments considered above pertain to the skate 10, in other embodiments, various other articles of athletic gear or other wearable articles may comprise expandable user-engaging structures constructed according to principles discussed herein in respect of the expandable user-engaging structure 12 of the skate 10.

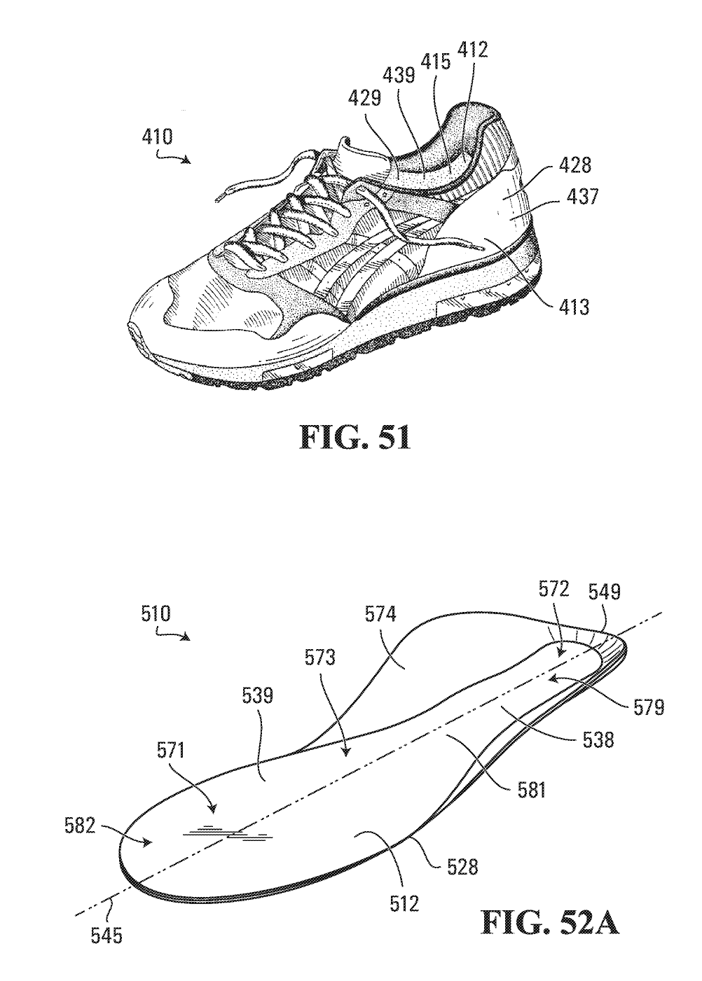

For example, in other embodiments, as shown in FIGS. 50 and 51, while the skate 10 is an example of footwear, other examples of footwear 410 wearable on a user's foot may comprise an expandable user-engaging structure 412 constructed according to principles discussed herein in respect of the expandable user-engaging structure 12 of the skate 10. For instance, in various embodiments, the footwear 410 may be a ski boot as shown in FIG. 50, a shoe (e.g., a running shoe or a dress shoe) as shown in FIG. 51, etc. The footwear 410 comprises an outer portion 437 comprising an outer surface 428 of the footwear 410 and an inner portion 439 comprising an inner surface 429 of the footwear 410. The outer portion 437 comprises an outer cover 413 and the inner portion 439 comprises a liner 415 that comprises the expandable user-engaging structure 412. The liner 415 may disposed between the outer cover 413 and the user's foot for comfort and/or shock absorption.

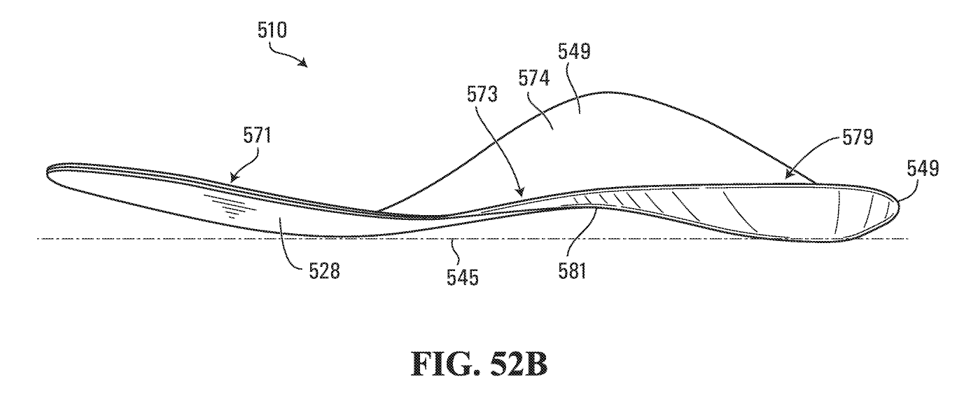

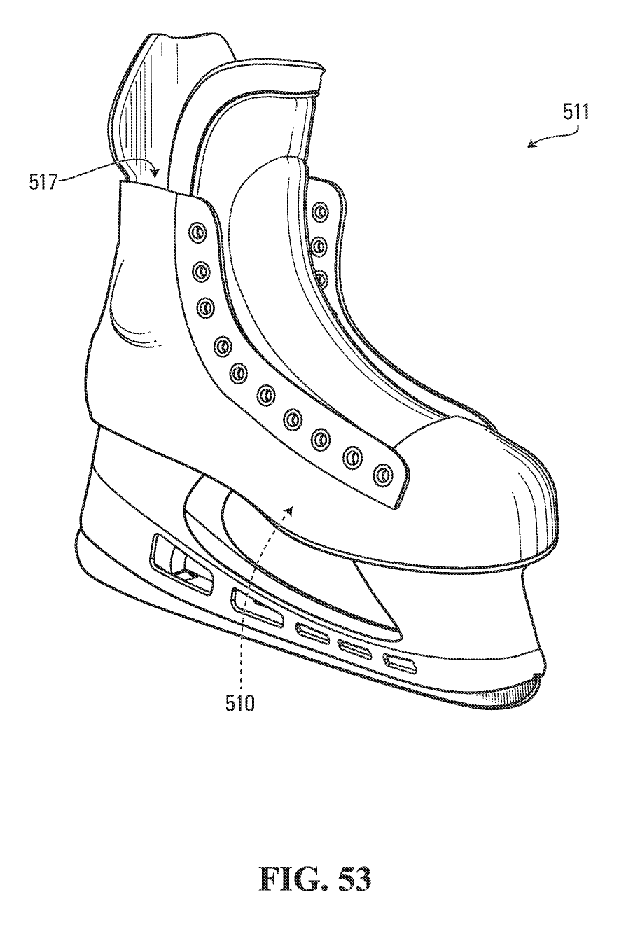

As another example, in some embodiments, as shown in FIGS. 52A, 52B and 53, a footbed 510 wearable on a user's foot while the user's foot is in a cavity 517 of footwear 511 (e.g., a skate, a ski boot, a shoe, etc.) may comprise an expandable user-engaging structure 512 constructed according to principles discussed herein in respect of the expandable user-engaging structure 12 of the skate 10. The footbed 510 comprises an inner surface 539 facing the user's foot 11 and an outer surface 528 opposite to the inner surface 539.

In this embodiment, the footbed 510 is elongated such that it has a longitudinal axis 545 defining a longitudinal direction of the footbed 510 and comprises a forefoot portion 571, a hindfoot portion 572, and a midfoot portion 573 to respectively engage the user's forefoot, hindfoot and midfoot. The inner surface 539 of the footbed 510 comprises a plantar surface 538 for engaging the plantar surface PS of the user's foot 11 when the user's foot 11 is received on the footbed 510. The footbed 510 comprises a wall 549 projecting upwardly from the plantar surface 538. In this example, the wall 549 is configured to turn about the user's heel H and face part of the medial side MS and part of the lateral side LS of the user's foot 11. The wall 549 includes an arched portion 574 that projects upwardly from the plantar surface 538 for engaging the arch ARC of the user's foot 11.

More particularly, in this embodiment, the footbed 510 has a longitudinal curvature, including an arch 581, along its longitudinal axis 45. The arch 581 defines a curve that is generally shaped longitudinally to overlap the midfoot of the user's foot 11. More specifically, the curve defined by the arch 581 is generally shaped longitudinally to overlap the arch ARC of the user's foot 11. The footbed 510 also has a transversal curvature, including that which defines the wall 549. The transversal curvature forms a concave portion 579 generally shaped to encompass the user's hindfoot. The transversal curvature may also include a concave portion 582 that overlaps the forefoot portion of the user's foot 11 and is less concave than the concave portion 579.

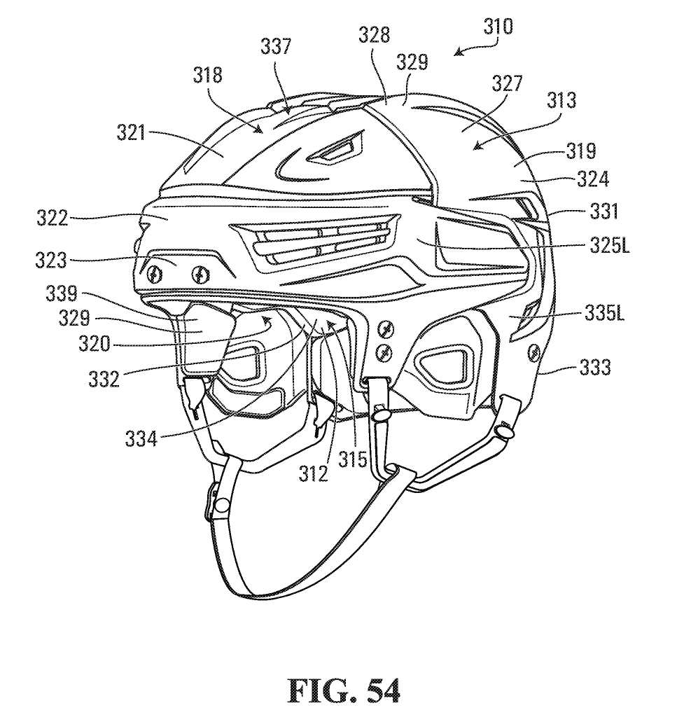

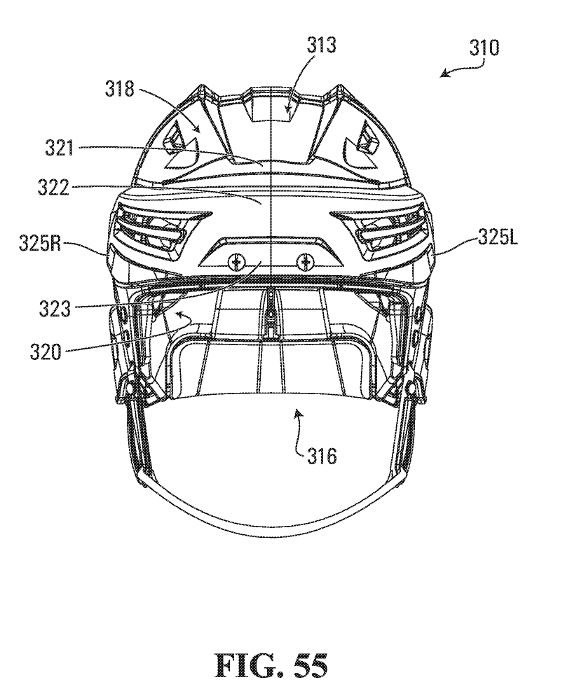

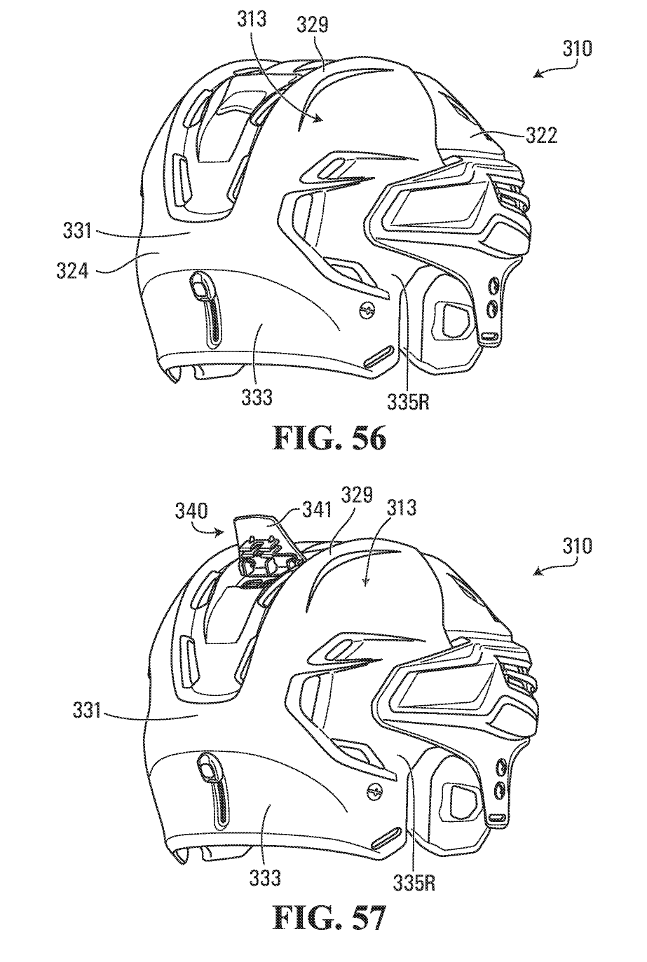

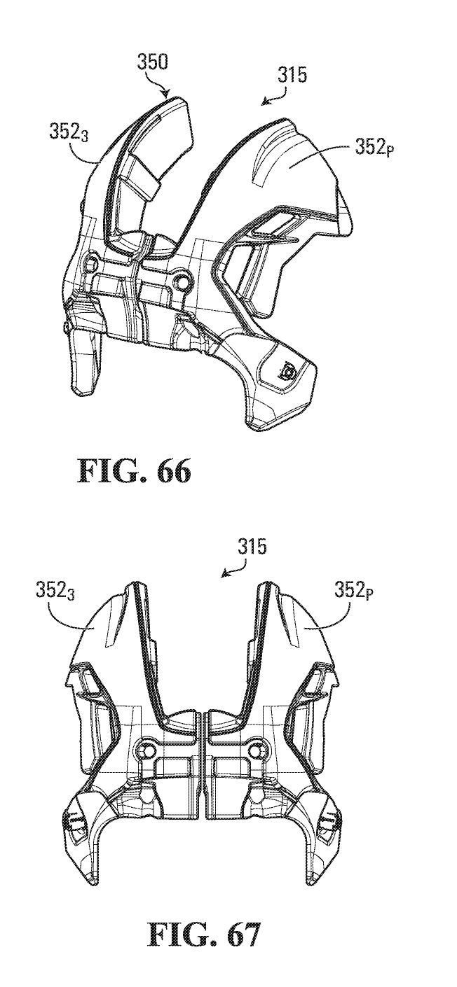

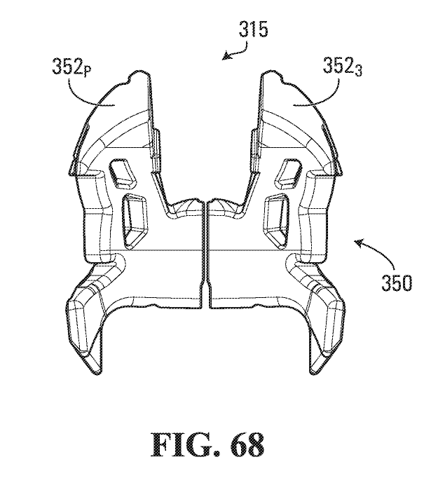

As another example, in some embodiments, as shown in FIGS. 54 to 68, an article of protective athletic gear 310 wearable by a user to protect him/her may comprise an expandable user-engaging structure 312 constructed according to principles discussed herein in respect of the expandable user-engaging structure 12 of the skate 10.

For example, in some embodiments, as shown in FIG. 54, the article of protective athletic gear 310 may be headgear, in this case a helmet, for protecting a head of the user against impacts (e.g., from a puck or ball, a hockey stick, a board, ice or another playing surface, etc., with another player, etc.). The helmet 310 comprises an outer portion 337 comprising an outer surface 328 of the helmet 310 and an inner portion 339 comprising an inner surface 329 of the helmet 310. The outer portion 337 comprises an outer shell 313 and the inner portion 339 comprises a liner 315 that comprises the expandable user-engaging structure 312. The liner 315 is disposed between the outer shell 313 and the user's head to absorb impact energy when the helmet 310 is impacted.

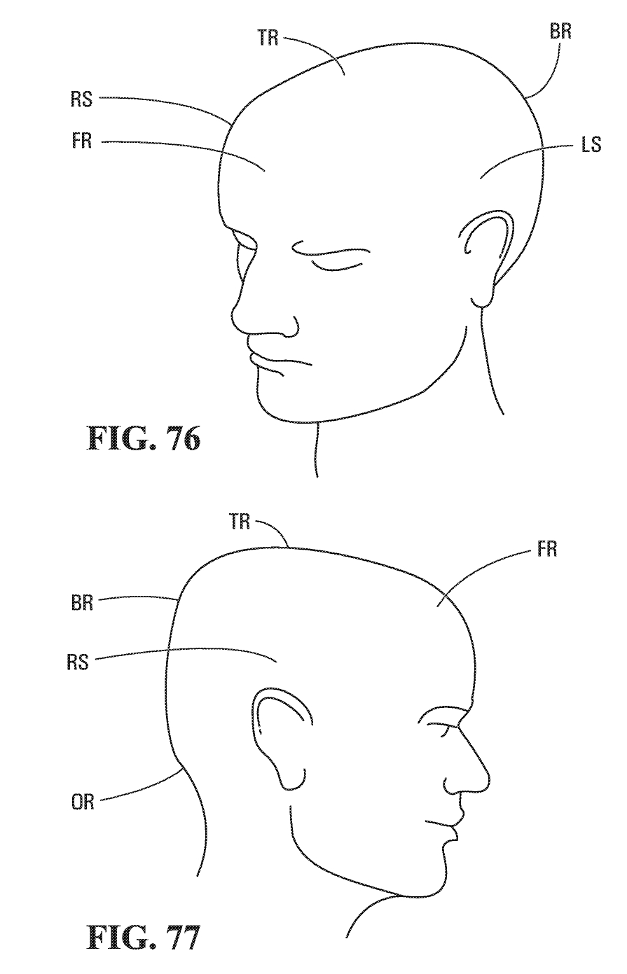

The helmet 310 defines a cavity 316 for receiving the user's head. As shown in FIGS. 76 and 77, the user's head comprises a front region FR, a top region TR, left and right side regions LS, RS which include left and right temple regions LT, RT, a back region BR, and an occipital region OR. The front region FR includes a forehead and a front top part of the user's head and generally corresponds to a frontal bone region of the user's head. The back region BR is opposite to the front region FR and includes a rear upper part of the user's head, while the occipital region OR substantially corresponds to a region around and under the head's occipital protuberance.

The outer shell 313 provides strength and rigidity to the helmet 310. To that end, the outer shell 313 comprises a rigid material 327. For example, in various embodiments, the rigid material 327 of the outer shell 313 may be a thermoplastic material such as polyethylene (PE), polyamide (nylon), or polycarbonate, a thermosetting resin, or any other suitable material. The outer shell 313 includes an inner surface 317 facing the liner 315 and an outer surface 319 opposite the inner surface 317. The outer surface 319 of the outer shell 313 constitutes at least part of an outer surface 318 of the helmet 310.

In this embodiment, the outer shell 313 comprises a front shell member 322 and a rear shell member 324 that are connected to one another. The front shell member 322 comprises a top portion 321 for facing at least part of a top region of the user's head, a front portion 323 for facing at least part of a front region of the user's head, and left and right lateral side portions 325L, 325R extending rearwardly from the front portion 323 for facing at least part of left and right side regions of the user's head, respectively. The rear shell member 324 comprises a top portion 329 for facing at least part of the top region of the user's head, a back portion 331 for facing at least part of a back region of the user's head, an occipital portion 333 for facing at least part of an occipital region of the user's head, and left and right lateral side portions 335L, 335R extending forwardly from the back portion 331 for facing at least part of the left and right side regions of the user's head, respectively.

In this embodiment, the helmet 310 is adjustable to adjust how it fits on the user's head. To that end, the helmet 310 comprises an adjustment mechanism 340 for adjusting a fit of the helmet 310 on the user's head. The adjustment mechanism 340 may allow the fit of the helmet 310 to be adjusted by adjusting one or more internal dimensions of the cavity 316 of the helmet 310 that is configured for receiving the user's head. For instance, this may include adjustment of a front-back internal dimension of the cavity 316 in the front-back direction of the helmet 310 and/or a left-right internal dimension of the cavity 316 in the left-right direction of the helmet 310.

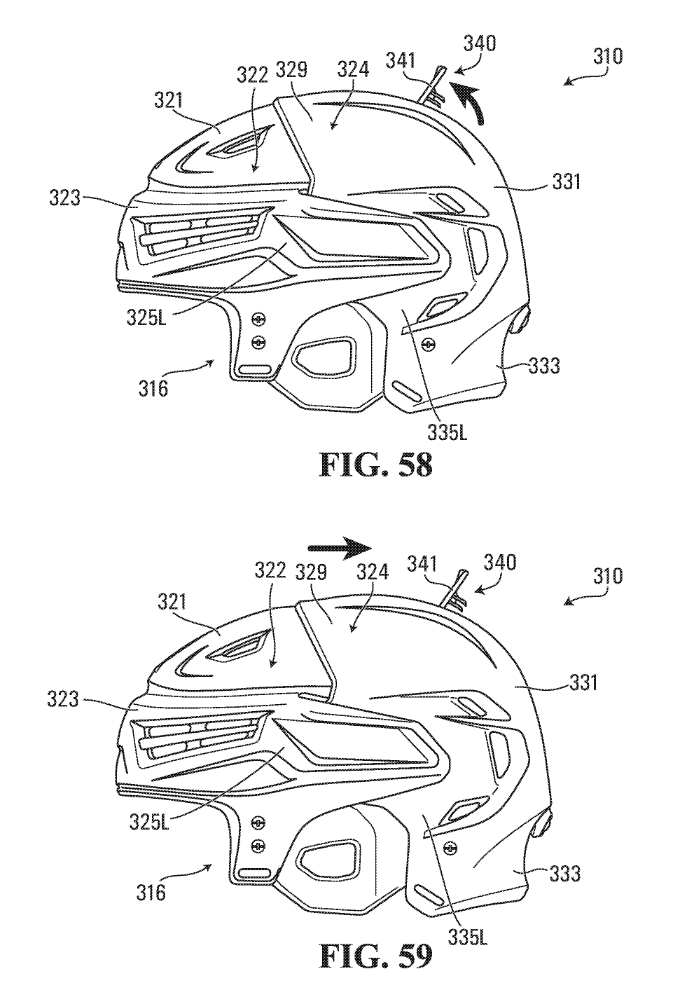

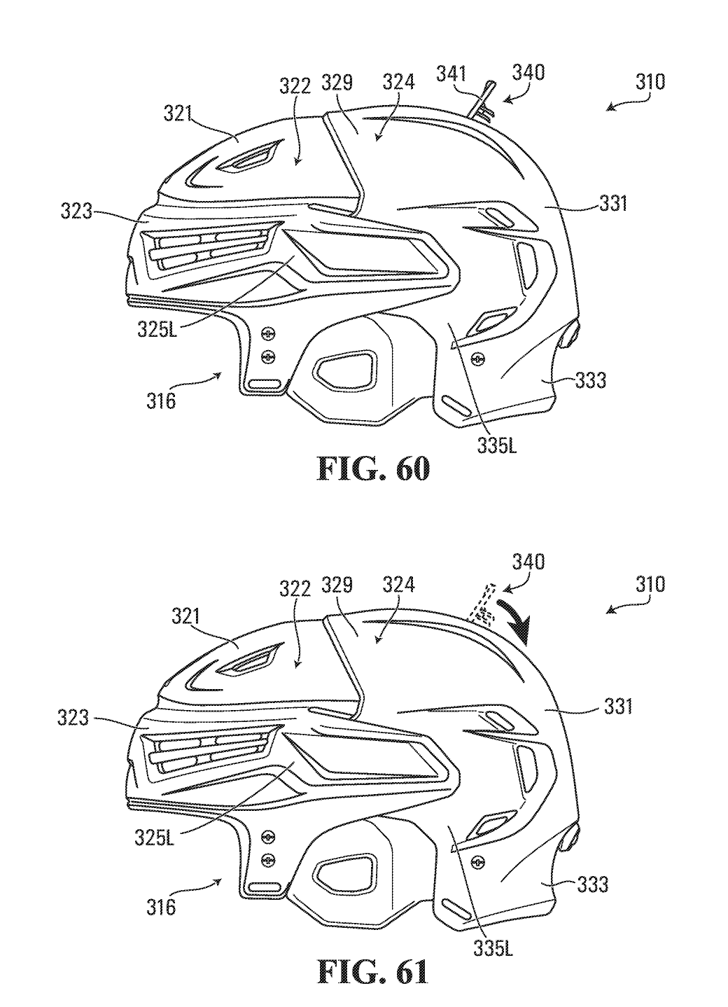

More particularly, in this embodiment, the adjustment mechanism 340 is configured such that the outer shell 313 and the liner 315 are adjustable to adjust the fit of the helmet 310 on the player's head. To that end, in this embodiment, the front shell member 322 and the rear shell member 324 are movable relative to one another to adjust the fit of the helmet 310 on the user's head. In this example, relative movement of the outer shell members 322, 324 for adjustment purposes is in the front-back direction of the helmet 310 such that the front-back internal dimension of the cavity 316 of the helmet 310 is adjusted. This is shown in FIGS. 58 to 61 in which the rear shell member 324 is moved relative to the front shell member 322 from a first position, which is shown in FIG. 58 and which corresponds to a minimum size of the helmet 310, to a second position, which is shown in FIG. 59 and which corresponds to an intermediate size of the helmet 310, and to a third position, which is shown in FIGS. 60 and 61 and which corresponds to a maximum size of the helmet 310.

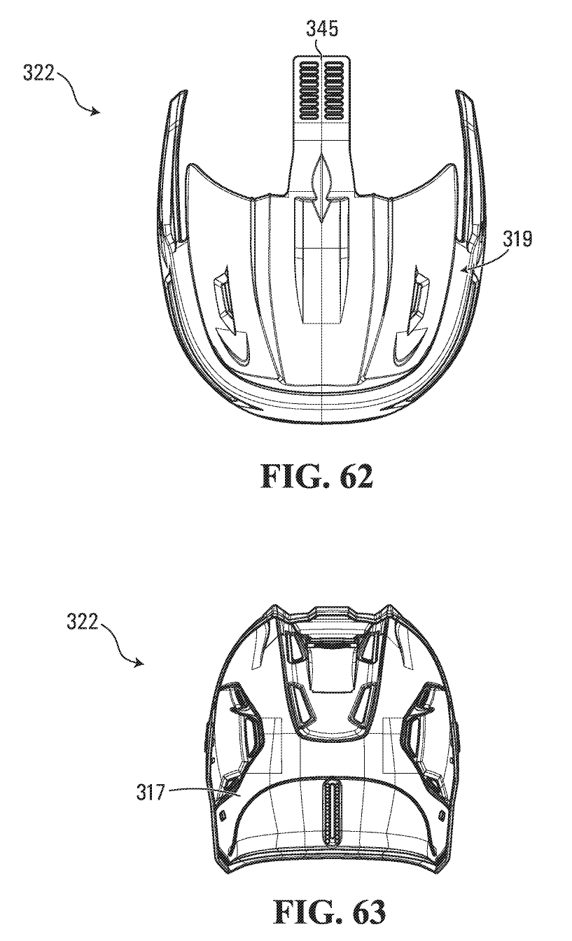

In this example of implementation, the adjustment mechanism 340 comprises an actuator 341 that can be moved (in this case pivoted) by the user between a locked position, in which the actuator 341 engages a locking part 345 (as best shown in FIGS. 62 and 63) of the front shell member 322 and thereby locks the outer shell members 322, 324 relative to one another, and a release position, in which the actuator 341 is disengaged from the locking part 345 of the front shell member 322 and thereby permits the outer shell members 322, 324 to move relative to one another so as to adjust the size of the helmet 310. The adjustment mechanism 340 may be implemented in any other suitable way in other embodiments.

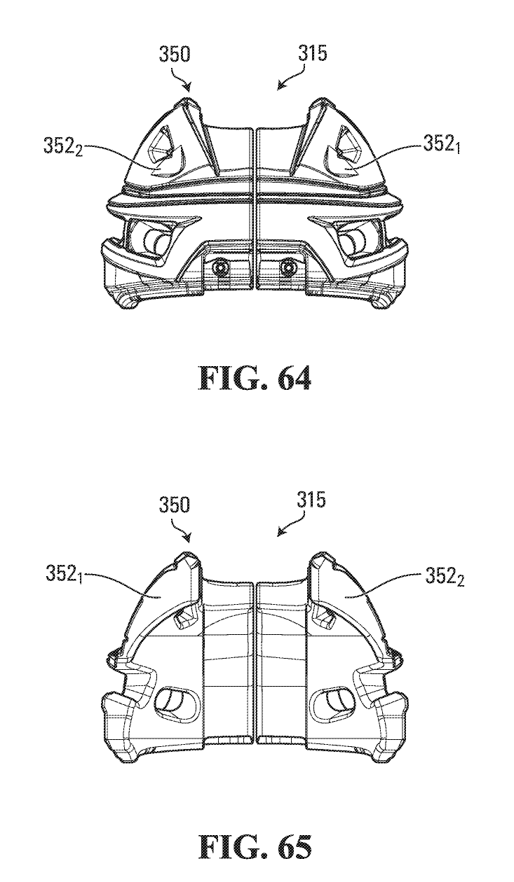

The expandable user-engaging structure 312 comprises padding 350 of the liner 315. In this embodiment, as shown in FIGS. 64 to 68, the padding 350 comprises a plurality of pads 352₁-352_{P} disposed between the outer shell 313 and the user's head when the helmet 310 is worn. Thus, in this embodiment, the expandable user-engaging structure 312 comprises the pads 352₁-352_{P} such that each pad 352; is expandable to conform to a respective region of the user's head.

For example, in this embodiment, respective ones of the pads 352₁-352_{P} may be expandable to conform to at least part of one or more of the front region FR, the back region BR, the top region TP, the left and right side regions LS, RS, and the occipital region OR of the user's head. For instance, in some cases, respective ones of the pads 352₁-352_{P} that are arranged to overlie the left and right temple regions LT, RT, the occipital region OR, the front region FR and the top region TR of the user's hear may be expandable to conform to these regions of the user's head.

Thus, in this example, to fit the helmet 310 on the user's head, first, the outer shell members 322, 324 of the outer shell 313 are adjusted via the adjustment mechanism 340 as described above. This allows respective ones of the pads 352₁-352_{P} to move relative to one another and with the outer shell members 322, 324 in order to modify the dimensions of the cavity 316 of the helmet 310. The helmet 310 is subsequently subjected to heat via a heat source 395 (e.g., an oven) which heats the expandable user-engaging structure 312. This causes the pads 352₁-352_{P} of the expandable user-engaging structure 312 to expand and conform to the user's head.

The headgear 310 may be configured in any other suitable way in other embodiments. For example, in some embodiments, the headgear 310 may not comprise the adjustment mechanism 340. As another example, in some embodiments, the headgear may be any other type of protective headgear. For instance, in some examples, the headgear 310 may be: a hockey goalie mask for wearing by a hockey goalie (i.e., goalkeeper); a lacrosse helmet for wearing by a lacrosse player; a catcher helmet or batting helmet for wearing by a baseball, softball or other ball-and-bat sport catcher, batter or other player; etc.

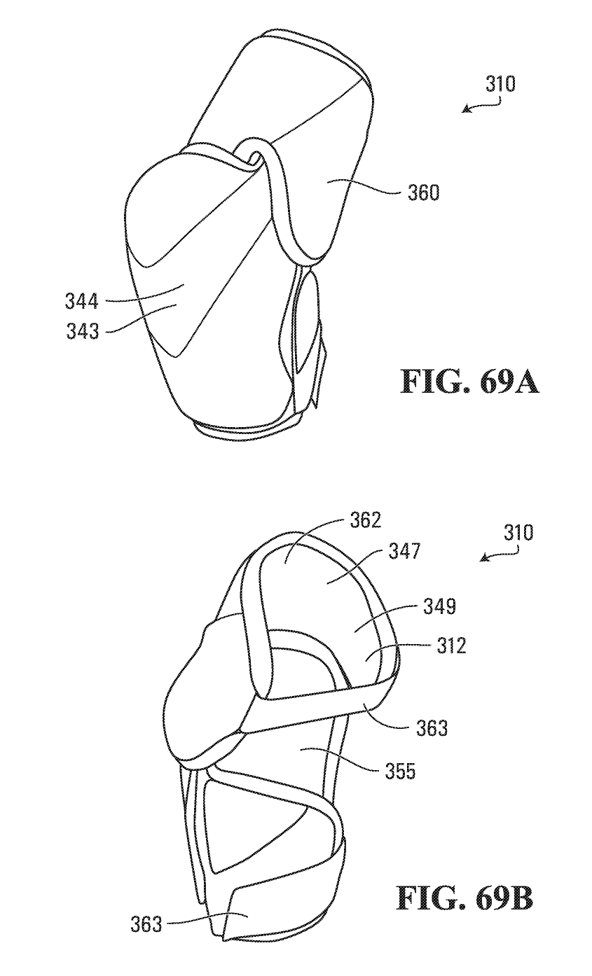

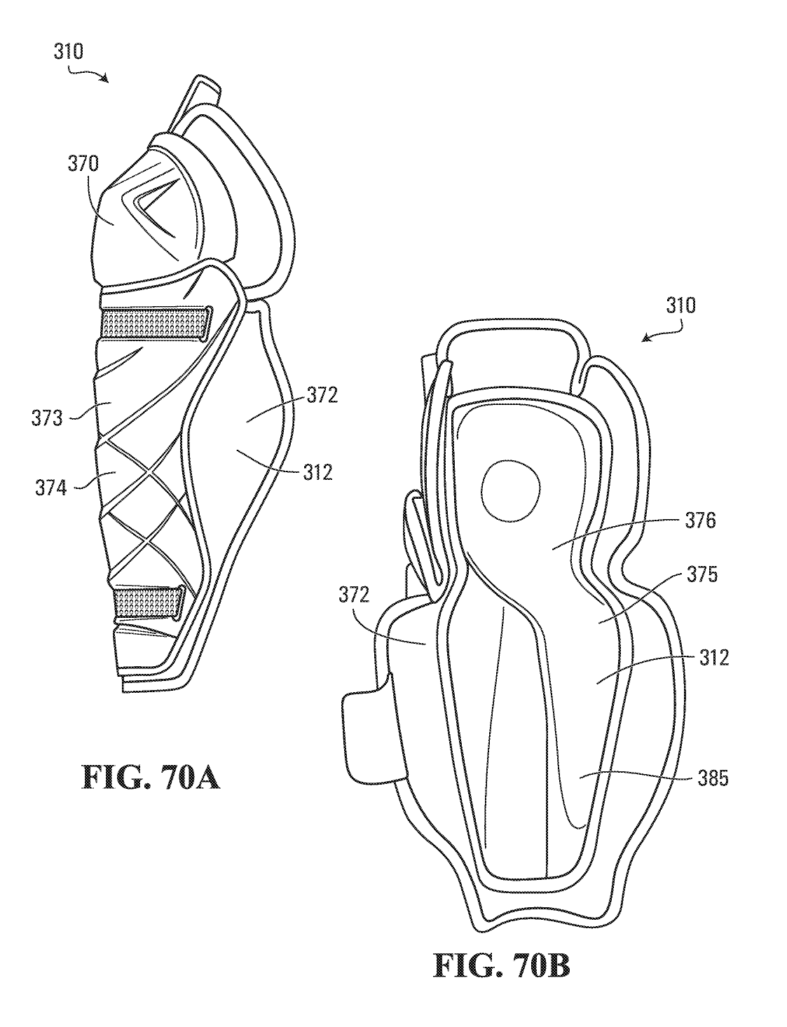

As another example, in some embodiments, as shown in FIGS. 69A and 69B, the article of protective athletic gear 310 may be an arm guard (e.g., an elbow pad) for protecting an arm (e.g., an elbow) of a user. The arm guard 310 comprises an outer portion 343 comprising an outer surface 344 of the arm guard 310 and an inner portion 347 comprising an inner surface 349 of the arm guard 310. The outer portion 343 comprises an outer cover 360 and the inner portion 347 comprises a liner 362 that comprises the expandable user-engaging structure 312. The liner 362 is disposed between the outer cover 360 and the user's arm (e.g., the user's elbow) and is expandable as it comprises the expandable user-engaging structure 312.

In this embodiment, the expandable user-engaging structure 312 comprises padding 355 of the liner 362. For example, in this embodiment, the padding 355 may be arranged to overlie an upper arm region (i.e., including a bicep region and/or a tricep region), a forearm arm region, and/or an elbow region of the user's arm, such that the expandable user-engaging structure 312 can be expanded to conform to the upper arm region, the forearm arm region, and/or the elbow region of the user's arm.

The arm guard 310 may also comprise one or more securing elements 363 for securing the arm guard 310 on the user's arm. For example, the securing elements 363 may comprise hook-and-loop straps, elastic bands or any other suitable securing mechanism. The arm guard 310 may thus be secured to the user's arm via the securing elements 363 and a fit of the arm guard 310 on the user's arm may be adjusted by subjecting the expandable user-engaging structure 312 of the liner 362 to a stimulus (e.g., heat) to cause the expandable user-engaging structure 312 to expand and thus conform to the user's arm or otherwise improve the fit of the arm guard 310 on the user's arm.

As yet another example, in some embodiments, as shown in FIGS. 70A and 70B, the article of protective athletic gear 310 may be a leg guard (e.g., a shin guard, a leg pad, etc.) for protecting a leg (e.g., a shin, a knee, and possibly a calf and/or a region above the knee) of a user. The leg guard 310 comprises an outer portion 373 comprising an outer surface 374 of the leg guard 310 and an inner portion 375 comprising an inner surface 376 of the leg guard 310. The outer portion 373 comprises an outer shell 370 and the inner portion 375 comprises a liner 372 that comprises the expandable user-engaging structure 312. In this example, the leg guard 310 extends from the user's lower shin to the user's knee. The liner 372 is disposed between the outer shell 370 and the user's leg and is expandable as it comprises the expandable user-engaging structure 312.

In this embodiment, the expandable user-engaging structure 312 comprises padding 385 of the liner 372. For example, in this embodiment, the padding 385 may be arranged to overlie a knee region (e.g., part of a knee pad), a shin region, and/or a calf region (e.g., part of a calf guard) of the user's leg, such that the expandable user-engaging structure 312 can be expanded to conform to the knee region, the shin region, and/or the calf region of the user's leg.

The leg guard 310 may also comprise securing elements (not shown) for securing the leg guard 310 to the user's leg. The securing elements may include hook-and-loop straps, elastic bands, or any other suitable securing mechanism. The leg guard 310 may thus be secured to the user's leg via the securing elements and a fit of the leg guard 310 on the user's leg may be adjusted by subjecting the expandable user-engaging structure 312 of the liner 372 to a stimulus (e.g., heat) to cause the expandable user-engaging structure 312 to expand and thus conform to the user's leg or otherwise improve the fit of the leg guard 310 on the user's leg.

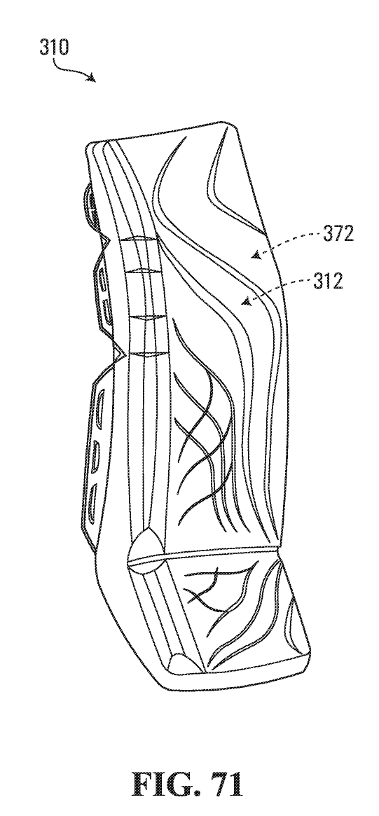

In one example, as shown in FIG. 71, the leg guard 310 may be a goalie leg pad for wearing by a hockey goalie. In such an example, the goalie leg pad 310 extends from the goalie's foot to above the goalie's knee. The liner 372 of the goalie leg pad 310 is expandable as it comprises the expandable user-engaging structure 312. As such, the goalie leg pad 310 may be secured to the goalie's leg and the fit of the goalie leg pad 310 on the goalie's leg may be adjusted by subjecting the expandable user-engaging structure 312 of the liner 372 to a stimulus (e.g., heat) to cause the expandable user-engaging structure 312 to expand and thus conform to the goalie's leg or otherwise improve the fit of the goalie leg pad 310 on the goalie's leg.

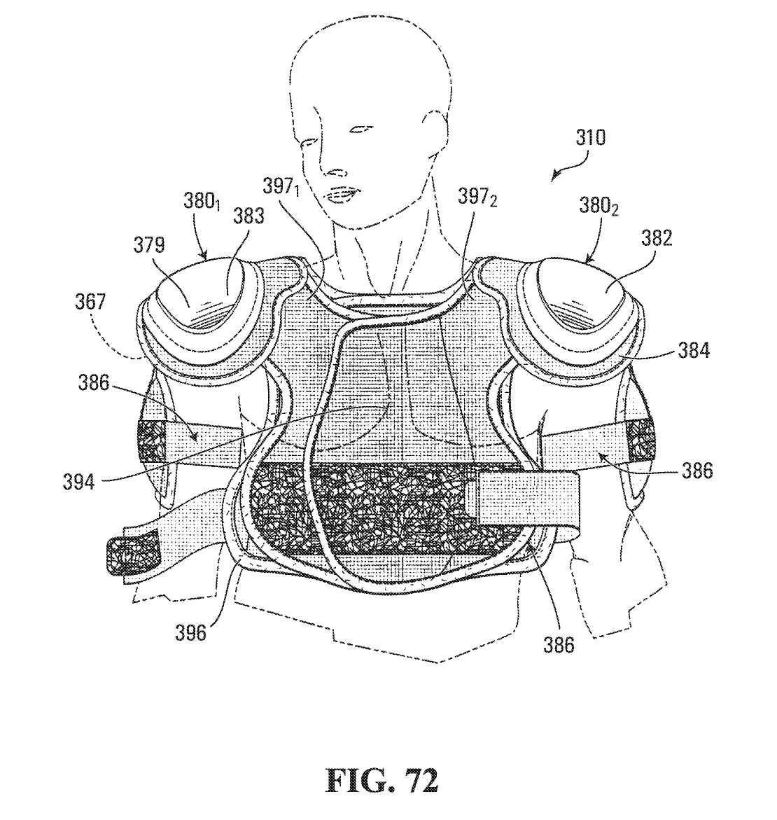

As yet another example, in some embodiments, as shown in FIG. 72, the article of protective athletic gear 310 may be a torso protector for protecting a torso (e.g., an upper torso including shoulders and/or a chest) of a user. In this embodiment, the torso protector 310 is shoulder pads for protecting an upper torso, including an upper chest and shoulders, of the user. The shoulder pads 310 comprise an outer portion 379 comprising an outer surface 383 of the shoulder pads 310 and an inner portion 381 comprising an inner surface 367 of the shoulder pads 310. The inner portion 381 comprises a liner 384 that comprises the expandable user-engaging structure 312. The liner 384 is disposed between the outer portion 382 and the user's upper torso and is expandable as it comprises the expandable user-engaging structure 312.

In this embodiment, the shoulder pads 310 comprise a front member 394 for overlying the user's chest, a back member 396 for overlying the user's back, arches 397₁, 397₂ interconnecting the front member 394 and the back member, and shoulder caps 380₁, 380₂. The front member 394, the back member 396, the arches 397₁, 397₂, and/or the shoulder caps 380₁, 380₂ may comprise part of the liner 384 comprising the expandable user-engaging structure 312 such that it can be expanded to conform to the user's upper torso. For example, in this embodiment, the arches 397₁, 397₂ and the shoulder caps 380₁, 380₂ may comprise part of the liner 384 comprising the expandable user-engaging structure 312.

The shoulder pads 310 may also comprise one or more securing elements 386 for securing the shoulder pads 310 to the user's torso. The securing elements 386 may include hook-and-loop straps, elastic bands, or any other suitable securing mechanism. The shoulder pads 310 may thus be secured to the user's torso via the securing elements 386 and a fit of the shoulder pads 310 on the user's torso may be adjusted by subjecting the expandable user-engaging structure 312 of the liner 384 to a stimulus (e.g., heat) to cause the expandable user-engaging structure 312 to expand and thus conform to the user's torso or otherwise improve the fit of the shoulder pads 310 on the user's torso.

The torso protector 310 may be configured in any other suitable way in other embodiments. For example, in some embodiments, the torso protector 310 may be a goalie chest protector for wearing by a hockey goalie or a catcher chest protector for wearing by a baseball, softball or other ball-and-bat sport catcher.

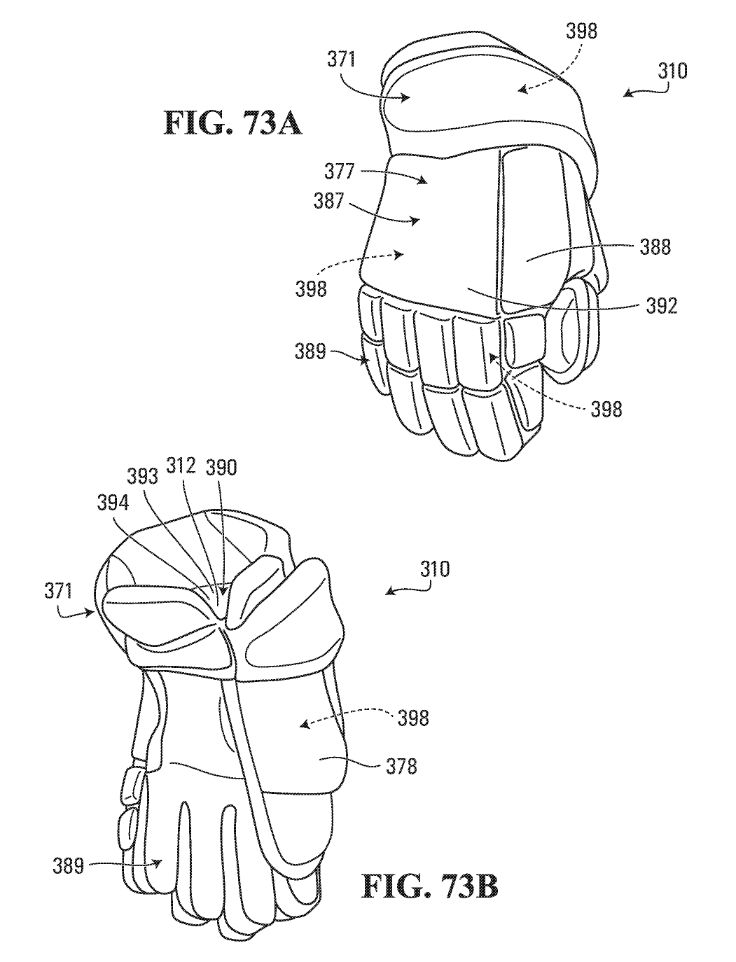

As yet another example, in some embodiments, as shown in FIGS. 73A and 73B, the article of protective athletic gear 310 may be a protective glove for protecting a hand of a user. In this embodiment, the protective glove 310 comprises an outer portion 387 comprising an outer surface 388 of the protective glove 310 and an inner portion 390 comprising an inner surface 393 of the protective glove 310. The inner portion 390 comprises a liner 394 that comprises the expandable user-engaging structure 312. The liner 394 is disposed between the outer portion 387 and the user's hand and is expandable as it comprises the expandable user-engaging structure 312.

In this embodiment, the expandable user-engaging structure 312 comprises padding 398 of the liner 394. For example, in this embodiment, the padding 398 may be disposed at a dorsal side of a hand-receiving portion 377 of the protective glove 310 to overlie a dorsal side of the user's hand, at a finger portion 389 of the protective glove 310 to overlie the fingers of the user's hand, at a thumb portion 378 of the protective glove 310 to overlie a thumb of the user's hand, and/or at a cuff portion 371 to overlie a wrist of the user, such that the expandable user-engaging structure 312 can be expanded to conform to the dorsal side, the fingers, the thumb of the user's hand, and/or the wrist of the user.

The protective glove 310 may be configured in any other suitable way in other embodiments. For example, in some embodiments, the protective glove may be a hockey goalie catching glove (i.e., catcher) or blocking glove (i.e., blocker) for wearing by a hockey goalie.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

To facilitate the description, any reference numeral designating an element in one figure designates that same element if used in any other figures. In describing the embodiments, specific terminology has been resorted to for the sake of description but this is not intended to be limiting and it is understood that each specific term comprises all equivalents.

In case of any discrepancy, inconsistency, or other difference between terms used herein and terms used in any document incorporated by reference herein, meanings of the terms used herein are to prevail and be used.

Although various embodiments have been illustrated, this was for purposes of description, but should not be limiting. Various modifications will become apparent to those skilled in the art.

1. A wearable article for wearing by a user, the wearable article comprising an expandable user-engaging structure configured to expand to conform to the user, the expandable user-engaging structure comprising an expandable material.

2. (canceled)

3. The wearable article of claim 1, wherein an expansion ratio of the expandable user-engaging structure is at least 1.3.

4. (canceled)

5. The wearable article of claim 1, wherein an expansion ratio of the expandable user-engaging structure is at least 1.7.

6. (canceled)

7. The wearable article of claim 1, wherein the expandable material is a cellular material

8. The wearable article of claim 7, wherein the cellular material is a foam.

9. The wearable article of claim 1, wherein the expandable material includes a mixture of a polymeric substance and an expansion agent.

10. (canceled)

11. (canceled)

12. (canceled)

13. The wearable article of claim 9, wherein the polymeric substance comprises polyurethane.

14. (canceled)

15. (canceled)

16. (canceled)

17. (canceled)

18. The wearable article of claim 9, wherein the expansion agent comprises expandable microspheres.

19. The wearable article of claim 1, wherein the expandable material is molded by a mold to impart an initial shape of the expandable material.

20. The wearable article of claim 19, wherein the expandable material is compressed during molding into the initial shape of the expandable material.

21. The wearable article of claim 20, wherein a pre-molding dimension of the expandable material prior to molding is larger than a post-molding dimension of the expandable material after molding.

22. The wearable article of claim 21, wherein a ratio of the pre-molding dimension of the expandable material over the post-molding dimension of the expandable material is at least 1.1.

23. (canceled)

24. The wearable article of claim 21, wherein a ratio of the pre-molding dimension of the expandable material over the post-molding dimension of the expandable material is at least 1.3.

25. (canceled)

26. The wearable article of claim 1, wherein the expandable user-engaging structure is configured to expand in response to heating of the expandable material.

27. The wearable article of claim 26, wherein expansion temperature of the expandable material is at least 50° C.

28. (canceled)

29. (canceled)

30. (canceled)

31. The wearable article of claim 26, wherein an expansion temperature of the expandable material is no more than 150° C.

32. (canceled)

33. The wearable article of claim 1, comprising an outer cover and a liner that comprises the expandable user-engaging structure.

34. The wearable article of claim 33, wherein the outer cover is an outer shell that is stiffer than the liner.

35. The wearable article of claim 1, wherein the expandable material comprises a user-engaging surface to contact the user.

36. The wearable article of claim 1, wherein the expandable user-engaging structure comprises a lining that overlies the expandable material and includes at least part of a user-engaging surface to contact the user.

37. (canceled)

38. The wearable article of claim 36, wherein the lining is deformable to accommodate expansion of the expandable material.

39. The wearable article of claim 38, wherein the lining is stretchable to accommodate expansion of the expandable material.

40. The wearable article of claim 1, wherein the expandable material is a first expandable material and the expandable user-engaging structure comprises a second expandable material different from the first expandable material.

41. (canceled)

42. The wearable article of claim 40, wherein the first expandable material is more expandable than the second expandable material.

43. (canceled)

44. (canceled)

45. The wearable article of claim 40, wherein the first expandable material and the second expandable material overlap.

46. The wearable article of claim 26, comprising a heater for generating heat to expand the expandable user-engaging structure.

47. The wearable article of claim 1, wherein the expandable user-engaging structure comprises a retainer and a plurality of expandable elements that are attached to the retainer and include respective portions of the expandable material.

48. (canceled)

49. (canceled)

50. (canceled)

51. (canceled)

52. The wearable article of claim 1, wherein the wearable article is an article of athletic gear.

53. The wearable article of claim 52, wherein the article of athletic gear is a skate.

54. The wearable article of claim 1, wherein the wearable article is footwear.

55. The wearable article of claim 1, wherein the wearable article is headgear.

56. The wearable article of claim 55, wherein the headgear is a helmet.

57. The wearable article of claim 1, wherein the wearable article is an article of protective gear to protect the user.

58. (canceled)

59. (canceled)

60. (canceled)

61. (canceled)

62. A skate boot for a skate, the skate comprising a skating device disposed beneath the skate boot to engage a skating surface, the skate boot comprising:
a cavity to receive a foot of a user; and
an expandable user-engaging structure configured to expand to conform to the user's foot, the expandable user-engaging structure comprising an expandable material.

63. The skate boot of claim 62, wherein the expandable user-engaging structure comprises a heel portion for receiving a heel of the user's foot.

64. The skate boot of claim 62, wherein the expandable user-engaging structure comprises an ankle portion for receiving an ankle of the user.

65. The skate boot of claim 62, wherein the expandable user-engaging structure comprises medial and lateral side portions for respectively facing medial and lateral sides of the user's foot.

66. The skate boot of claim 62, wherein the expandable user-engaging structure comprises a toe portion for receiving toes of the user's foot.

67. The skate boot of claim 62, wherein the expandable user-engaging structure comprises a sole portion for facing a plantar surface of the user's foot.

68. (canceled)

69. (canceled)

70. (canceled)

71. (canceled)

72. (canceled)

73. A skate comprising the skate boot of claim 62.

74. (canceled)

75. Footwear comprising:
a cavity to receive a foot of a user; and
an expandable user-engaging structure configured to expand to conform to the user's foot, the expandable user-engaging structure comprising an expandable material.

76. (canceled)
